(19) United States
(12) Patent Application Publication
(10) Pub. No.: US 2024/0422631 A1
(43) Pub. Date: Dec. 19, 2024

(54) CELL GROUP TRANSMISSION CONFIGURATION INDICATOR MANAGEMENT FOR LAYER 1/LAYER 2 TRIGGERED MOBILITY

(71) Applicant: QUALCOMM Incorporated, San Diego, CA (US)

(72) Inventors: Jelena DAMNJANOVIC, Del Mar, CA (US); Tao LUO, San Diego, CA (US); Naeem AKL, Bridgewater, NJ (US)

(21) Appl. No.: 18/335,930

(22) Filed: Jun. 15, 2023

(51) Int. Cl. H04W 36/00; H04W 36/08

(52) U.S. Cl. CPC H04W 36/0072; H04W 36/0058; H04W 36/08

(57) ABSTRACT

Various aspects of the present disclosure generally relate to wireless communication. In some aspects, a user equipment (UE) may receive, from a first network node, configuration information indicating a layer 1/layer 2 triggered mobility (LTM) candidate cell associated with a second network node and a configuration, for the LTM candidate cell, of uplink resources associated with a plurality of transmission configuration indicator (TCI) states. The UE may transmit, to the first network node, layer 1 (L1) measurements associated with the LTM candidate cell. The UE may receive, from the first network node, an LTM medium access control (MAC) control element (MAC-CE) triggering LTM to the LTM candidate cell, the LTM MAC-CE indicating a TCI state. The UE may transmit, to the second network node via the LTM candidate cell, an uplink communication on an uplink resource associated with the TCI state. Numerous other aspects are described.

### FIELD OF THE DISCLOSURE

Aspects of the present disclosure generally relate to wireless communication and to techniques and apparatuses for cell group transmission configuration indicator management for layer 1/layer 2 triggered mobility.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The UE may include one or more memories and one or more processors coupled to the one or more memories. The one or more processors may be configured to receive, from a first network node, configuration information indicating a layer 1/layer 2 triggered mobility (LTM) candidate cell associated with a second network node and a configuration, for the LTM candidate cell, of respective uplink resources associated with a plurality of transmission configuration indicator (TCI) states. The one or more processors may be configured to transmit, to the first network node, a layer 1 (L1) measurement report indicating one or more L1 measurements associated with the LTM candidate cell. The one or more processors may be configured to receive, from the first network node, an LTM medium access control (MAC) control element (MAC-CE) triggering LTM to the LTM candidate cell, the LTM MAC-CE indicating a TCI state, of the plurality of TCI states, to be used for the LTM candidate cell. The one or more processors may be configured to transmit, to the second network node via the LTM candidate cell, an uplink communication on an uplink resource associated with the TCI state.

Some aspects described herein relate to a first network node for wireless communication. The first network node may include one or more memories and one or more processors coupled to the one or more memories. The one or more processors may be configured to receive, from a second network node, an indication of a TCI group associated with a cell or cell group (CG), associated with the first network node, that is an LTM candidate cell or CG for one or more UEs, wherein the TCI group includes one or more candidate TCI states for the cell or CG. The one or more processors may be configured to monitor uplink resources associated with the one or more candidate TCI states of the TCI group. The one or more processors may be configured to receive, from a UE of the one or more UEs and on an uplink resource associated with a candidate TCI state of the one or more candidate TCI states of the TCI group, an uplink communication associated with LTM to the cell or CG.

Some aspects described herein relate to a first network node for wireless communication. The first network node may include one or more memories and one or more processors coupled to the one or more memories. The one or more processors may be configured to transmit, to one or more UEs, configuration information indicating an LTM candidate cell or CG associated with a second network node and a configuration, for the LTM candidate cell or CG, of respective uplink resources associated with a plurality of TCI states. The one or more processors may be configured to receive, from the one or more UEs, L1 measurement reports indicating one or more L1 measurements associated with the LTM candidate cell. The one or more processors may be configured to transmit, to the second network node, an indication of a TCI group associated with the LTM candidate cell or CG associated with the second network node, wherein the TCI group includes one or more candidate TCI states, of the plurality of TCI states, for the LTM candidate cell or CG.

Some aspects described herein relate to a method of wireless communication performed by a UE. The method may include receiving, from a first network node, configuration information indicating an LTM candidate cell associated with a second network node and a configuration, for the LTM candidate cell, of respective uplink resources associated with a plurality of TCI states. The method may include transmitting, to the first network node, an L1 measurement report indicating one or more L1 measurements associated with the LTM candidate cell. The method may include receiving, from the first network node, an LTM MAC-CE triggering LTM to the LTM candidate cell, the LTM MAC-CE indicating a TCI state, of the plurality of TCI states, to be used for the LTM candidate cell. The method may include transmitting, to the second network node via the LTM candidate cell, an uplink communication on an uplink resource associated with the TCI state.

Some aspects described herein relate to a method of wireless communication performed by a first network node. The method may include receiving, from a second network node, an indication of a TCI group associated with a cell or CG, associated with the first network node, that is an LTM candidate cell or CG for one or more UEs, wherein the TCI group includes one or more candidate TCI states for the cell or CG. The method may include monitoring uplink resources associated with the one or more candidate TCI states of the TCI group. The method may include receiving, from a UE of the one or more UEs and on an uplink resource associated with a candidate TCI state of the one or more candidate TCI states of the TCI group, an uplink communication associated with LTM to the cell or CG.

Some aspects described herein relate to a method of wireless communication performed by a first network node. The method may include transmitting, to one or more UEs, configuration information indicating an LTM candidate cell or CG associated with a second network node and a configuration, for the LTM candidate cell or CG, of respective uplink resources associated with a plurality of TCI states. The method may include receiving, from the one or more UEs, L1 measurement reports indicating one or more L1 measurements associated with the LTM candidate cell. The method may include transmitting, to the second network node, an indication of a TCI group associated with the LTM candidate cell or CG associated with the second network node, wherein the TCI group includes one or more candidate TCI states, of the plurality of TCI states, for the LTM candidate cell or CG.

Some aspects described herein relate to a non-transitory computer-readable medium that stores a set of instructions for wireless communication by a UE. The set of instructions, when executed by one or more processors of the UE, may cause the UE to receive, from a first network node, configuration information indicating an LTM candidate cell associated with a second network node and a configuration, for the LTM candidate cell, of respective uplink resources associated with a plurality of TCI states. The set of instructions, when executed by one or more processors of the UE, may cause the UE to transmit, to the first network node, an L1 measurement report indicating one or more L1 measurements associated with the LTM candidate cell. The set of instructions, when executed by one or more processors of the UE, may cause the UE to receive, from the first network node, an LTM MAC-CE triggering LTM to the LTM candidate cell, the LTM MAC-CE indicating a TCI state, of the plurality of TCI states, to be used for the LTM candidate cell. The set of instructions, when executed by one or more processors of the UE, may cause the UE to transmit, to the second network node via the LTM candidate cell, an uplink communication on an uplink resource associated with the TCI state.

Some aspects described herein relate to a non-transitory computer-readable medium that stores a set of instructions for wireless communication by a first network node. The set of instructions, when executed by one or more processors of the first network node, may cause the first network node to receive, from a second network node, an indication of a TCI group associated with a cell or CG, associated with the first network node, that is an LTM candidate cell or CG for one or more UEs, wherein the TCI group includes one or more candidate TCI states for the cell or CG. The set of instructions, when executed by one or more processors of the first network node, may cause the first network node to monitor uplink resources associated with the one or more candidate TCI states of the TCI group. The set of instructions, when executed by one or more processors of the first network node, may cause the first network node to receive, from a UE of the one or more UEs and on an uplink resource associated with a candidate TCI state of the one or more candidate TCI states of the TCI group, an uplink communication associated with LTM to the cell or CG.

Some aspects described herein relate to a non-transitory computer-readable medium that stores a set of instructions for wireless communication by a first network node. The set of instructions, when executed by one or more processors of the first network node, may cause the first network node to transmit, to one or more UEs, configuration information indicating an LTM candidate cell or CG associated with a second network node and a configuration, for the LTM candidate cell or CG, of respective uplink resources associated with a plurality of TCI states. The set of instructions, when executed by one or more processors of the first network node, may cause the first network node to receive, from the one or more UEs, L1 measurement reports indicating one or more L1 measurements associated with the LTM candidate cell. The set of instructions, when executed by one or more processors of the first network node, may cause the first network node to transmit, to the second network node, an indication of a TCI group associated with the LTM candidate cell or CG associated with the second network node, wherein the TCI group includes one or more candidate TCI states, of the plurality of TCI states, for the LTM candidate cell or CG.

Some aspects described herein relate to an apparatus for wireless communication. The apparatus may include means for receiving, from a first network node, configuration information indicating an LTM candidate cell associated with a second network node and a configuration, for the LTM candidate cell, of respective uplink resources associated with a plurality of TCI states. The apparatus may include means for transmitting, to the first network node, an L1 measurement report indicating one or more L1 measurements associated with the LTM candidate cell. The apparatus may include means for receiving, from the first network node, an LTM MAC-CE triggering LTM to the LTM candidate cell, the LTM MAC-CE indicating a TCI state, of the plurality of TCI states, to be used for the LTM candidate cell. The apparatus may include means for transmitting, to the second network node via the LTM candidate cell, an uplink communication on an uplink resource associated with the TCI state.

Some aspects described herein relate to an apparatus for wireless communication. The apparatus may include means for receiving, from a network node, an indication of a TCI group associated with a cell or CG, associated with the apparatus, that is an LTM candidate cell or CG for one or more UEs, wherein the TCI group includes one or more candidate TCI states for the cell or CG. The apparatus may include means for monitoring uplink resources associated with the one or more candidate TCI states of the TCI group. The apparatus may include means for receiving, from a UE of the one or more UEs and on an uplink resource associated with a candidate TCI state of the one or more candidate TCI states of the TCI group, an uplink communication associated with LTM to the cell or CG.

Some aspects described herein relate to an apparatus for wireless communication. The apparatus may include means for transmitting, to one or more UEs, configuration information indicating an LTM candidate cell or CG associated with a network node and a configuration, for the LTM candidate cell or CG, of respective uplink resources associated with a plurality of TCI states. The apparatus may include means for receiving, from the one or more UEs, L1 measurement reports indicating one or more L1 measurements associated with the LTM candidate cell. The apparatus may include means for transmitting, to the network node, an indication of a TCI group associated with the LTM candidate cell or CG associated with the second network node, wherein the TCI group includes one or more candidate TCI states, of the plurality of TCI states, for the LTM candidate cell or CG.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a layer 1/layer2 triggered mobility (LTM) procedure, in accordance with the present disclosure.

FIG. 5 is a diagram illustrating an example of an LTM cell switch, in accordance with the present disclosure.

FIG. 6 is a diagram illustrating an example associated with cell group (CG) transmission configuration indicator (TCI) management for inter-distributed-unit (inter-DU) LTM, in accordance with the present disclosure.

FIG. 7 is a diagram illustrating an example associated with CG TCI management for inter-DU LTM, in accordance with the present disclosure.

FIG. 8 is a diagram illustrating an example associated with CG TCI management for inter-DU LTM, in accordance with the present disclosure.

FIG. 9 is a diagram illustrating an example process performed, for example, by a UE, in accordance with the present disclosure.

FIG. 10 is a diagram illustrating an example process performed, for example, by a first network node, in accordance with the present disclosure.

FIG. 11 is a diagram illustrating an example process performed, for example, by a first network node, in accordance with the present disclosure.

FIG. 12 is a diagram of an example apparatus for wireless communication, in accordance with the present disclosure.

FIG. 13 is a diagram of an example apparatus for wireless communication, in accordance with the present disclosure.

### DETAILED DESCRIPTION

In some wireless networks, a user equipment (UE) may be configured to perform layer 1 (L1) and/or layer 2 (L2) based cell changes, which is sometimes referred to as L1/L2 triggered mobility (LTM). In an LTM cell switch, a UE may be triggered to switch from a source cell to a target cell. In some examples, an LTM cell switch may be from a source cell associated with one distributed unit (DU) to a target cell associated with another DU. Such an LTM cell switch may be referred to as an inter-DU LTM cell switch. In some examples, in the case of an inter-DU LTM cell switch, the source cell can determine a transmission configuration indicator (TCI) state for the UE to use on the target cell when the LTM switch is triggered. The source cell may notify the UE (e.g., via an indication in a cell switch command transmitted from the source cell to the UE) of which beam (e.g., which TCI state) to use when the UE switches to the target cell. In such examples, once the DU associated with the source cell (e.g., the source DU) determines to trigger the LTM cell switch and determines the TCI state for the UE to use on the target cell, the source DU may need to notify the target DU about the TCI information and may additionally need to wait for the target DU to confirm the TCI information, prior to the UE transmitting an uplink communication to the target cell using the TCI state. Backhaul latency associated with backhaul communications between the source DU and the target DU may delay the execution of the LTM cell switch, which may result in reduced throughput, beam failure detection (BFD), and/or radio link failure (RLF).

Various aspects generally relate to cell group (CG) TCI management for LTM. Some aspects more specifically relate to CG TCI management for inter-network-node (e.g., inter-DU) LTM. In some examples, a first network node (e.g., a source DU) may transmit, and a UE may receive, configuration information indicating an LTM candidate cell or CG associated with a second network node (e.g., a target DU). The configuration information may further indicate a configuration, for the LTM candidate cell or CG, of respective uplink resources associated with a plurality of TCI states. The UE may transmit, and the first network node may receive, an L1 measurement report indicating one or more L1 measurements associated with the LTM candidate cell or CG. In some examples, the first network node may transmit, and the second network node may receive, an indication of a TCI group associated with the LTM candidate cell or CG. The TCI group may include one or more candidate TCI states, of the plurality of TCI states, for the LTM candidate cell or cell group. The second network node may monitor uplink resources associated with the one or more candidate TCI states of the TCI group. In some examples, the UE may receive, from the first network node, a cell switch command (e.g., a MAC-CE) triggering LTM (e.g., an LTM cell switch) to the LTM candidate cell or CG, and the cell switch command may indicate a TCI state, of the plurality of TCI states, to be used for the LTM candidate cell or CG. The UE may transmit, to the second network node via the candidate cell or CG, an uplink communication on an uplink resource associated with the TCI state. The second network node, based at least in part on monitoring the uplink resources associated with the one or more candidate TCI states of the TCI group, may receive the uplink communication.

Particular aspects of the subject matter described in this disclosure can be implemented to realize one or more of the following potential advantages. In some examples, by notifying the second network node of the TCI group, including candidate TCI states, for the LTM candidate cell or CG, and transmitting the uplink communication on an uplink resource associated with the TCI state indicated in the MAC-CE, the described techniques can be used to reduce backhaul delay associated with the first network node notifying the second network node of the TCI information for the UE once the LTM determination is made, which may result in increased throughput, decreased BFD, and/or decreased RLF.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

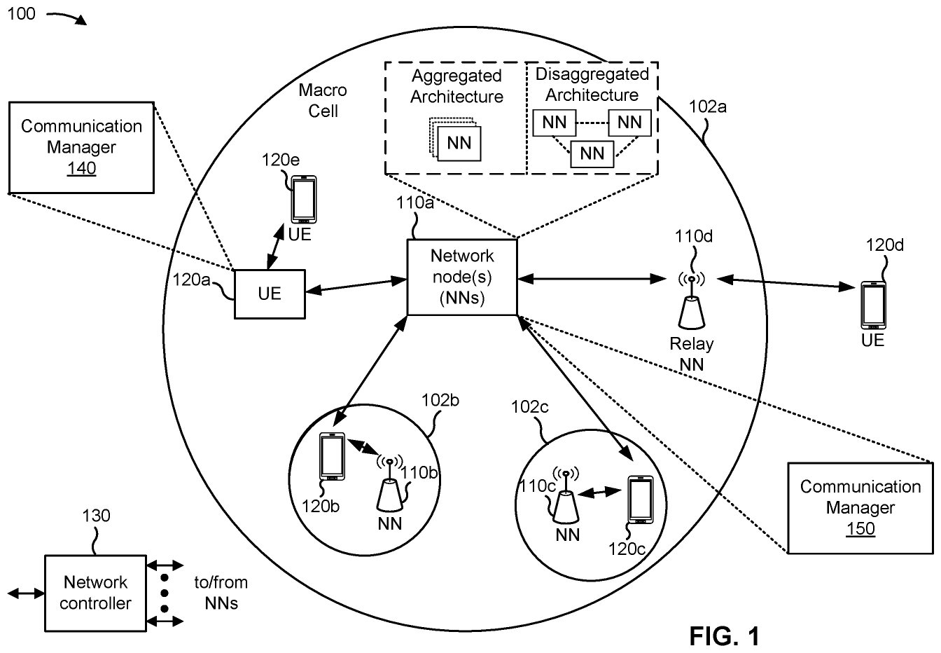

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more DUs, or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a first network node, configuration information indicating an LTM candidate cell associated with a second network node and a configuration, for the LTM candidate cell, of respective uplink resources associated with a plurality of TCI states; transmit, to the first network node, an L1 measurement report indicating one or more L1 measurements associated with the LTM candidate cell; receive, from the first network node, an LTM medium access control (MAC) control element (MAC-CE) triggering LTM to the LTM candidate cell, the LTM MAC-CE indicating a TCI state, of the plurality of TCI states, to be used for the LTM candidate cell; and transmit, to the second network node via the LTM candidate cell, an uplink communication on an uplink resource associated with the TCI state. Additionally, or alternatively, the communication manager 140 may perform one or more other operations described herein.

In some aspects, the network node 110 may include a communication manager 150. As described in more detail elsewhere herein, the communication manager 150 may receive, from another network node, an indication of a TCI group associated with a cell or CG, associated with the network node, that is an LTM candidate cell or CG for one or more UEs, wherein the TCI group includes one or more candidate TCI states for the cell or CG; monitor uplink resources associated with the one or more candidate TCI states of the TCI group; and receive, from a UE of the one or more UEs and on an uplink resource associated with a candidate TCI state of the one or more candidate TCI states of the TCI group, an uplink communication associated with LTM to the cell or CG.

Additionally or alternatively, as described in more detail elsewhere herein, the communication manager 150 may transmit, to one or more UEs, configuration information indicating an LTM candidate cell or CG associated with another network node and a configuration, for the LTM candidate cell or CG, of respective uplink resources associated with a plurality of TCI states; receive, from the one or more UEs, L1 measurement reports indicating one or more L1 measurements associated with the LTM candidate cell; and transmit, to the other network node, an indication of a TCI group associated with the LTM candidate cell or CG associated with the second network node, wherein the TCI group includes one or more candidate TCI states, of the plurality of TCI states, for the LTM candidate cell or CG. Additionally, or alternatively, the communication manager 150 may perform one or more other operations described herein.

As indicated above, FIG. 1 is provided as an example. Other examples may differ from what is described with regard to FIG. 1.

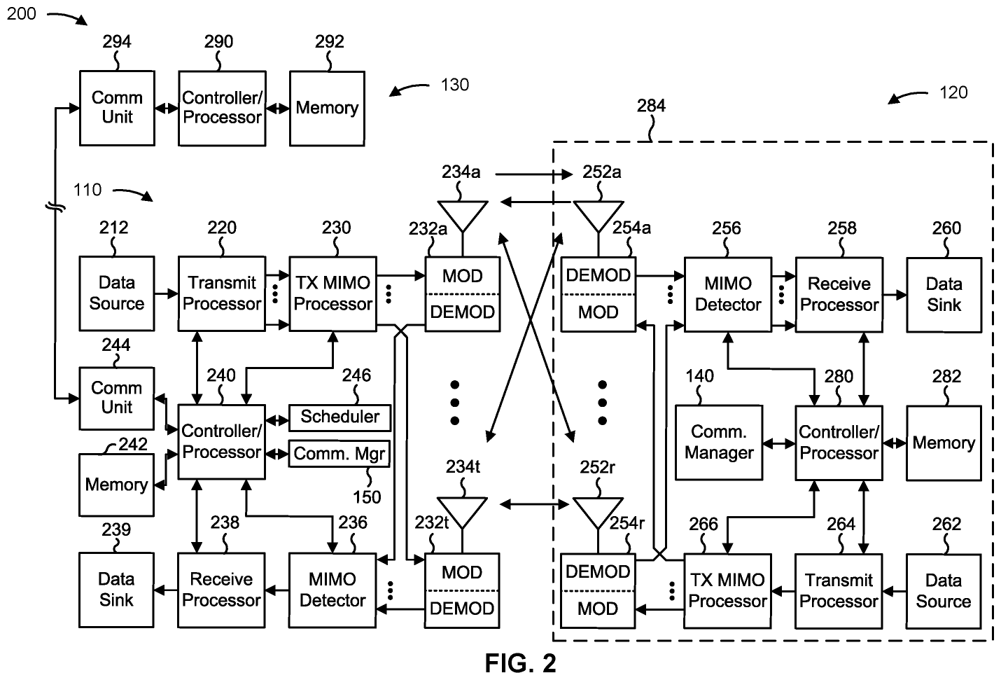

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

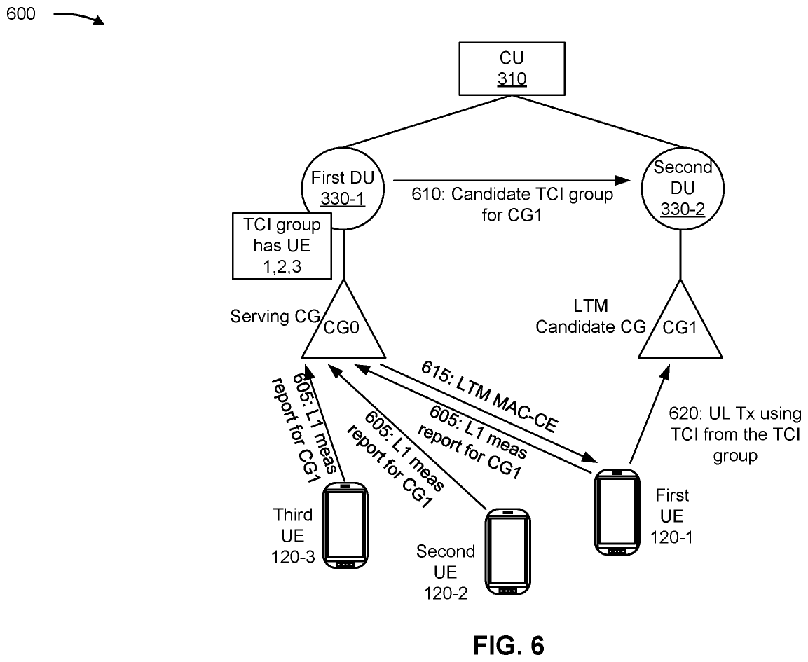

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 6-13).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 6-13).

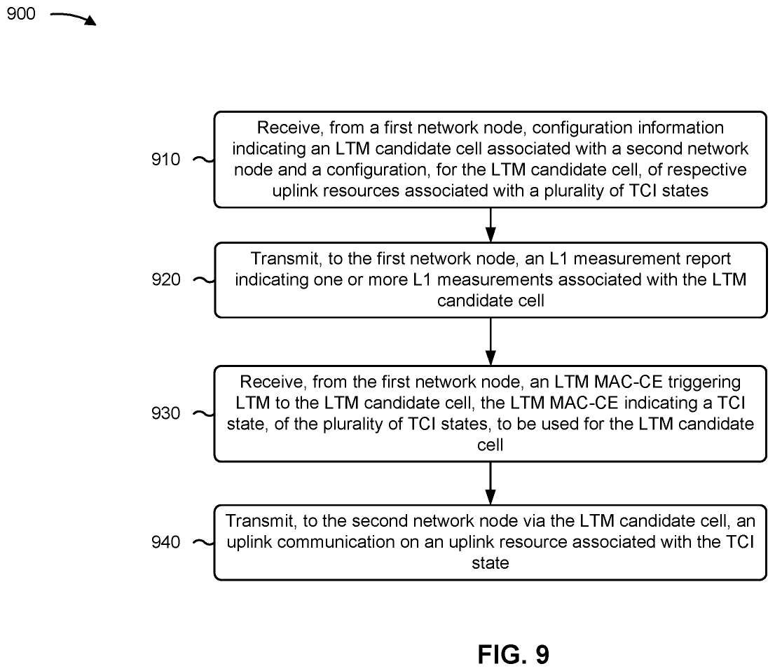

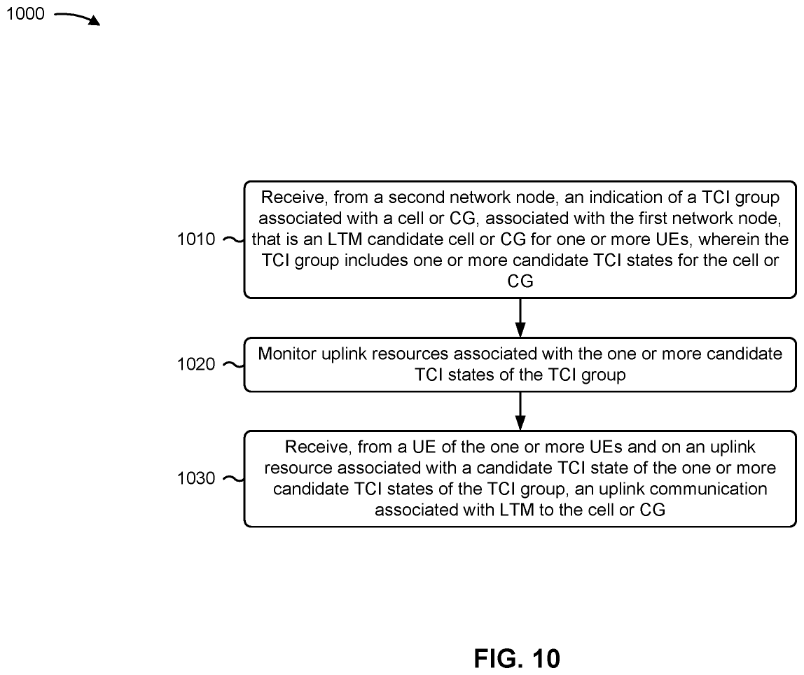

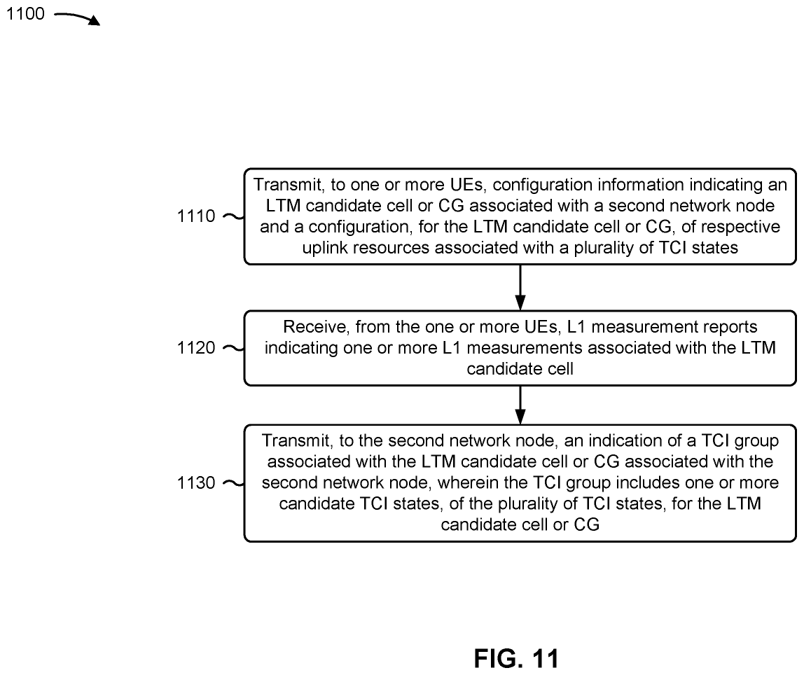

The controller/processor 240 of the network node 110, the controller/processor 280 of the UE 120, and/or any other component(s) of FIG. 2 may perform one or more techniques associated with CG TCI management for LTM, as described in more detail elsewhere herein. For example, the controller/processor 240 of the network node 110, the controller/processor 280 of the UE 120, and/or any other component(s) of FIG. 2 may perform or direct operations of, for example, process 900 of FIG. 9, process 1000 of FIG. 10, process 1100 of FIG. 11, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 900 of FIG. 9, process 1000 of FIG. 10, process 1100 of FIG. 11, and/or other processes as described herein. In some examples, executing instructions may include running the instructions, converting the instructions, compiling the instructions, and/or interpreting the instructions, among other examples.

In some aspects, a UE (e.g., the UE 120) includes means for receiving, from a first network node, configuration information indicating an LTM candidate cell associated with a second network node and a configuration, for the LTM candidate cell, of respective uplink resources associated with a plurality of TCI states; means for transmitting, to the first network node, an L1 measurement report indicating one or more L1 measurements associated with the LTM candidate cell; means for receiving, from the first network node, an LTM MAC-CE triggering LTM to the LTM candidate cell, the LTM MAC-CE indicating a TCI state, of the plurality of TCI states, to be used for the LTM candidate cell; and/or means for transmitting, to the second network node via the LTM candidate cell, an uplink communication on an uplink resource associated with the TCI state. The means for the UE to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, a network node (e.g., the network node 110) includes means for receiving, from another network node, an indication of a TCI group associated with a cell or CG, associated with the network node, that is an LTM candidate cell or CG for one or more UEs, wherein the TCI group includes one or more candidate TCI states for the cell or CG; means for monitoring uplink resources associated with the one or more candidate TCI states of the TCI group; and/or means for receiving, from a UE of the one or more UEs and on an uplink resource associated with a candidate TCI state of the one or more candidate TCI states of the TCI group, an uplink communication associated with LTM to the cell or CG.

In some aspects, a network node (e.g., the network node 110) includes means for transmitting, to one or more UEs, configuration information indicating an LTM candidate cell or CG associated with another network node and a configuration, for the LTM candidate cell or CG, of respective uplink resources associated with a plurality of TCI states; means for receiving, from the one or more UEs, L1 measurement reports indicating one or more L1 measurements associated with the LTM candidate cell; and/or means for transmitting, to the other network node, an indication of a TCI group associated with the LTM candidate cell or CG associated with the second network node, wherein the TCI group includes one or more candidate TCI states, of the plurality of TCI states, for the LTM candidate cell or CG. The means for the first network node to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

In some aspects, an individual processor may perform all of the functions described as being performed by the one or more processors. In some aspects, one or more processors may collectively perform a set of functions. For example, a first set of (one or more) processors of the one or more processors may perform a first function described as being performed by the one or more processors, and a second set of (one or more) processors of the one or more processors may perform a second function described as being performed by the one or more processors. The first set of processors and the second set of processors may be the same set of processors or may be different sets of processors. Reference to “one or more processors” should be understood to refer to any one or more of the processors described in connection with FIG. 2. Reference to “one or more memories” should be understood to refer to any one or more memories of a corresponding device, such as the memory described in connection with FIG. 2. For example, functions described as being performed by one or more memories can be performed by the same subset of the one or more memories or different subsets of the one or more memories.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

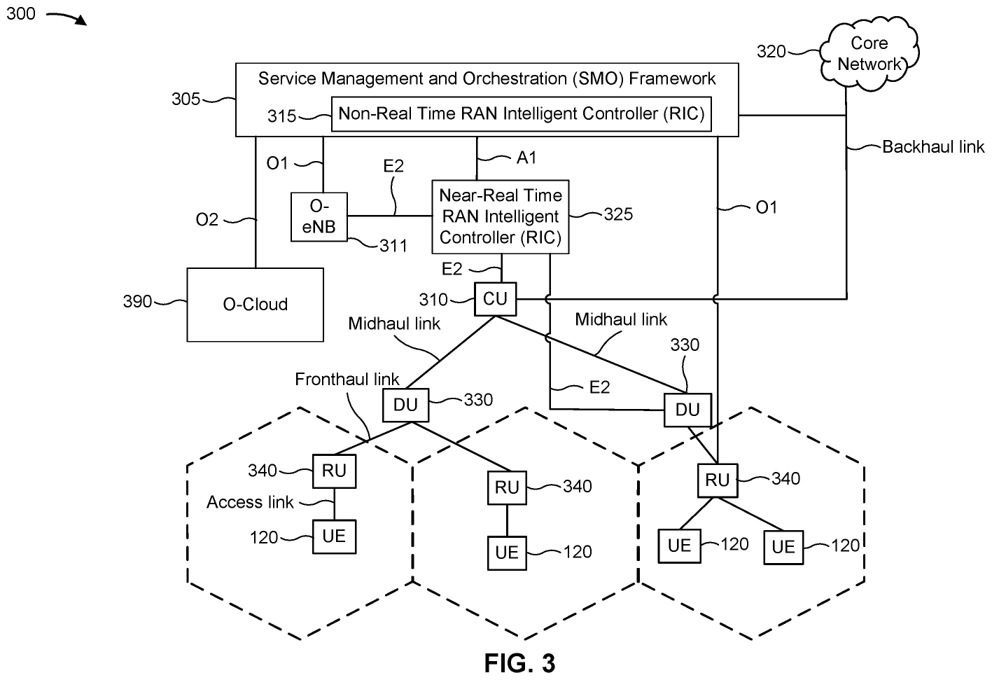

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a MAC layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

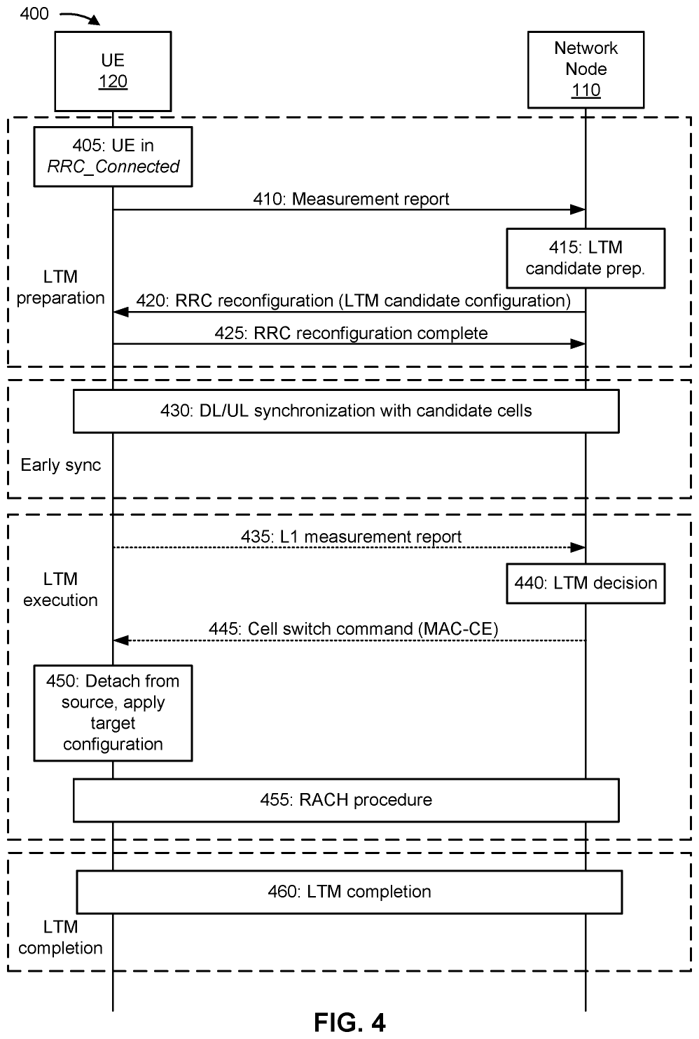

FIG. 4 is a diagram illustrating an example 400 of an LTM procedure, in accordance with the present disclosure.

In some examples, a network node 110 may instruct a UE 120 to change serving cells, such as when the UE 120 moves away from coverage of a current serving cell (sometimes referred to as a source cell) and towards coverage of a neighboring cell (sometimes referred to as a target cell). In some cases, the network node 110 may instruct the UE 120 to change cells using a layer 3 (L3) handover procedure. An L3 handover procedure may include the network node 110 transmitting, to the UE 120, an RRC reconfiguration message indicating that the UE 120 should perform a handover procedure to a target cell, which may be transmitted in response to the UE 120 providing the network node 110 with an L3 measurement report indicating signal strength measurements associated with various cells (e.g., measurements associated with the source cell and one or more neighboring cells). In response to receiving the RRC reconfiguration message, the UE 120 may communicate with the source cell and the target cell to detach from the source cell and connect to the target cell (e.g., the UE 120 may establish an RRC connection with the target cell). Once handover is complete, the target cell may communicate with a user plane function (UPF) of a core network to instruct the UPF to switch a user plane path of the UE 120 from the source cell to the target cell. The target cell may also communicate with the source cell to indicate that handover is complete and that the source cell may be released.

L3 handover procedures may be associated with high latency and high overhead due to the multiple RRC reconfiguration messages and/or other L3 signaling and operations used to perform the handover procedures. Accordingly, in some examples, a UE 120 may be configured to perform a lower-layer (e.g., L1 and/or L2) handover procedure, sometimes referred to an LTM procedure, such as the example 400 LTM procedure shown in FIG. 4. As shown in FIG. 4, the LTM procedure may include four phases: an LTM preparation phase, an early synchronization phase (shown as “early sync” in FIG. 4), an LTM execution phase, and/or an LTM completion phase.

During the LTM preparation phase, and as indicated by reference number 405, the UE 120 may be in an RRC connected state (sometimes referred to as RRC_Connected) with a source cell. As indicated by reference number 410, the UE 120 may transmit, and the network node 110 may receive, a measurement report (sometimes referred to as a MeasurementReport), which may be an L3 measurement report. The measurement report may indicate signal strength measurements (e.g., RSRP, RSSI, RSRQ, and/or CQI) or similar measurements associated with the source cell and/or one or more neighboring cells. In some examples, based at least in part on the measurement report or other information, the network node 110 may decide to use LTM, and thus, as indicated by reference number 415, the network node 110 may initiate LTM candidate preparation.

As shown by reference number 420, the network node 110 may transmit, and the UE 120 may receive, an RRC reconfiguration message (sometimes referred to as an RRCReconfiguration message), which may include an LTM candidate configuration. More particularly, the RRC reconfiguration message may indicate a configuration of one or more LTM candidate target cells, which may be candidate cells to become a serving cell of the UE and/or cells for which the UE 120 may later be triggered to perform an LTM procedure. As shown by reference number 425, the UE 120 may store the configuration of the one or more LTM candidate cell configurations and, in response, may transmit, to the network node 110, an RRC reconfiguration complete message (sometimes referred to as an RRCReconfigurationComplete message).

During the early synchronization phase, and as indicated by reference number 430, the UE 120 may optionally perform downlink/uplink synchronization with the candidate cells associated with the one or more LTM candidate cell configurations. For example, the UE 120 may perform downlink synchronization and timing advance (TA) acquisition with the one or more candidate target cells prior to receiving an LTM switch command (which is described in more detail below in connection with reference number 445). In some examples, performing the early synchronization with the one or more candidate cells may reduce latency associated with performing a random access channel (RACH) procedure later in the LTM procedure, which is described in more detail below in connection with reference number 455.

During the LTM execution phase, and as indicated by reference number 435, the UE 120 may perform L1 measurements on the configured LTM candidate target cells, and thus may transmit, to the network node 110, lower-layer (e.g., L1) measurement reports. As indicated by reference number 440, based at least in part on the lower-layer measurement reports, the network node 110 may decide to execute an LTM cell switch to a target cell. Accordingly, as shown by reference number 445, the network node 110 may transmit, and the UE 120 may receive, a MAC-CE or similar message triggering an LTM cell switch (the MAC-CE or similar message is sometimes referred to herein as a cell switch command). The cell switch command may include an indication of a candidate configuration index associated with the target cell. As shown by reference number 450, based at least in part on receiving the cell switch command, the UE 120 may switch to the configuration of the LTM candidate target cell (e.g., the UE 120 may detach from the source cell and apply the target cell configuration). Moreover, as shown by reference number 455, the UE 120 may perform a RACH procedure towards the target cell, such as when a timing advance associated with the target cell is not available (e.g., in examples in which the UE 120 did not perform the early synchronization as described above in connection with reference number 430).

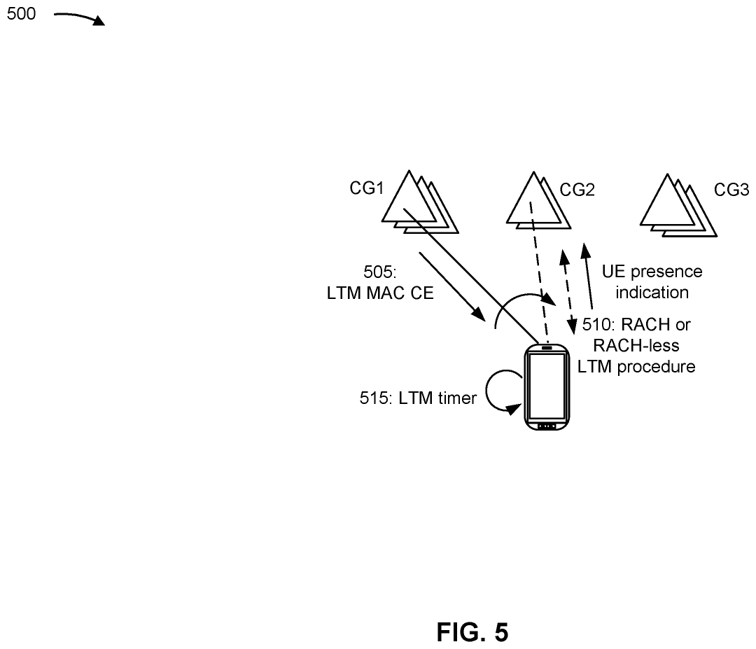

During the LTM completion phase, and as indicated by reference number 460, the UE 120 may indicate successful completion of the LTM cell switch towards the target cell. In this way, cell switch to a target cell may be performed using less overhead than for an L3 handover procedure and/or a cell switch to a target cell may be associated with reduced latency as compared to L3 handover procedure. Aspects of an LTM candidate cell configuration are described in more detail below in connection with FIG. 5.

As indicated above, FIG. 4 is provided as an example. Other examples may differ from what is described with respect to FIG. 4.

FIG. 5 is a diagram illustrating an example 500 of an LTM cell switch, in accordance with the present disclosure.

As described above in connection with FIG. 4, in some examples, LTM may be configured via RRC, and, more particularly, via an RRC reconfiguration message (e.g., the RRC reconfiguration message described above in connection with reference number 420). In some examples, the RRC reconfiguration message may indicate certain data structures and/or information elements (IEs), such as a CG configuration (sometimes referred to as a CellGroupConfig IE), a radio bearer configuration (sometimes referred to as a RadioBearerConfig IE), a measurement configuration (sometimes referred to as a MeasConfig IE), a master key update configuration (sometimes referred to as a MasterKey Update IE), and/or other configuration information (sometimes referred to as an OtherConfig IE). In some aspects, the CG configuration may include configuration information associated with one or more candidate target cells. For example, the CellGroupConfig IE may be used to configure a master cell group (MCG) or a secondary cell group (SCG). A CG may include one MAC entity, a set of logical channels with associated RLC entities, a primary cell associated with the corresponding MCG or the corresponding SCG (e.g., a primary cell (PCell) in the case of an MCG or a primary secondary cell (PSCell) in the case of an SCG, with each being more broadly referred to as a special cell (SpCell)), and one or more secondary cells (SCells) associated with the corresponding MCG or the corresponding SCG. In that regard, the cell group configuration may include an SpCell configurations (sometimes referred to as an SpCellConfig IE) and/or one or more SCell configurations (sometimes referred to as SCellConfig IEs).

In some examples, a serving cell index IE (sometimes referred to as a ServCelllndex IE) may indicate a short identity used to uniquely identify a serving cell (e.g., indicate the SpCell or an SCell as the serving cell). For example, the serving cell index IE may indicate value “0” when the SpCell is the serving cell, and may indicate an SCell index value (sometimes referred to SCellIndex) of a corresponding SCell when an SCell is the serving cell. The SCell index value for the one or more SCells of a CG may be configured via the CellGroupConfig IE.

In some examples, a UE may be configured with one RRC reconfiguration message for each candidate LTM configuration (which is sometimes referred to as “RRC model 1”). That is, each candidate LTM configuration (e.g., each CG configuration) may be indicated to the UE via a respective RRC reconfiguration message. In some other examples, a UE 120 may be configured with a single RRC reconfiguration message including multiple candidate LTM configurations (which is sometimes referred to as “RRC model 2”). For example, an RRC reconfiguration message may include multiple cell group configurations (e.g., multiple CellGroupConfig IEs), one for each candidate LTM configuration. In that regard, each candidate LTM configuration may be associated with a configuration identifier (ID) and a cell group configuration (e.g., a CellGroupConfig IE), and, optionally, a radio bearer configuration (e.g., a RadioBearerConfig IE) and/or a measurement configuration (e.g., a MeasConfig IE), among other information.

As shown in FIG. 5, a UE 120 may be configured with multiple candidate CGs for LTM. For example, the UE 120 may be configured with multiple candidate CG configurations (e.g., multiple CellGroupConfig IEs) via a single RRC configuration message or via a respective RRC configuration message for each CG configuration. In the example 500 shown in FIG. 5, the UE 120 may be configured with a configuration of a first CG (shown as “CG1”), a configuration of a second CG (shown as “CG2”), and a configuration of a third CG (shown as “CG3”), among other cell group configurations. Each CG may include one or more cells, such as an SpCell and one or more SCells. In some examples, some cells may be included in multiple CGs, while, in some other examples, some CGs may include distinct cells from other CGs. Additionally, or alternatively, certain CGs may include more or fewer cells than other CGs. For example, in the example 500 shown in FIG. 5, the first CG and the third CG may each be associated with three cells, and the second CG may be associated with two cells.

In some examples, the UE 120 may receive a cell switch command from a network node, and may perform an LTM procedure in a similar manner as described above in connection with FIG. 4. For example, the UE 120 may be initially connected to the first CG and, as shown by reference number 505, the UE 120 may receive an LTM MAC-CE (e.g., a cell switch command) from a network node associated with the first CG. The LTM MAC-CE may indicate LTM trigger information to trigger the UE 120 to perform an LTM procedure to switch to the second CM. For example, the LTM trigger information may include at least a candidate configuration index that indicates an LTM candidate configuration (e.g., a CG configuration) corresponding to the second CG.

As shown by reference number 510, the UE 120, based at least in part on receiving the LTM MAC-CE, may switch to the second CG by establishing a connection with the second CG using a RACH procedure or a RACH-less procedure. In some examples, both the RACH and RACH-less procedures for LTM may be supported. For example, the UE 120 may use the RACH-less procedure to establish the connection with the second CG in a case in which the UE 120 does not need to acquire the TA during the cell switch (e.g., due to the TA being acquired in the early synchronization phase, as described in connection with reference number 430 of FIG. 4). The UE 120 may use the RACH procedure to establish the connection with the second CG in a case in which the UE has not acquired the TA prior to the cell switch (e.g., in examples in which the UE 120 did not perform the early synchronization described in connection with reference number 430 of FIG. 4). The RACH procedure may be a contention-free random access (CFRA) procedure or a contention-based random access procedure (CBRA). In examples in which the UE 120 uses the CFRA procedure, a RACH resource for CFRA for an LTM dynamic cell switch may be indicated via RRC configuration (e.g., in the RRC configuration message including one or more LTM candidate configurations). As further shown in FIG. 5, the LTM procedure (e.g., the RACH-less procedure or the RACH procedure) may include a UE presence indication, transmitted by the UE 120 to the target cell (e.g., the target cell in the second cell group), that indicates the arrival of the UE 120 in the target cell.

As shown by reference number 515, the LTM cell switch may be supervised by an LTM timer. For example, the LTM timer may be a T304 timer or a similar timer defined by a wireless communication standard (e.g., a 3GPP standard). The UE 120 may start the LTM timer when the UE 120 receives the LTM MAC-CE, and stop the LTM timer when the UE successfully completes the cell switch to the second CG (e.g., when the UE successfully completes the RACH procedure or the RACH-less procedure for establishing the connection with the second CG). The LTM cell switch may fail in a case in which the LTM timer expires prior to the LTM cell switch being successfully completed.

An LTM cell switch, such as the LTM cell switch shown in FIG. 5, can be an intra-DU cell switch or an inter-DU cell switch. In an intra-DU LTM cell switch, the source CG (e.g., the first CG in FIG. 5) and the target CG (e.g., the second CG in FIG. 5) are associated with the same DU. That is, the source DU associated with the source CG is the same as the target DU associated with the target CG. In an inter-DU LTM cell switch, the source CG (e.g., the first CG in FIG. 5) and the target CG (e.g., the second CG in FIG. 5) are associated with different DUs. That is, the source DU associated with the source CG is different from the target DU associated with the target CG. In the case of an inter-DU LTM cell switch, the source DU and the target DU may communicate via backhaul communication (e.g., via communications with a CU).

In some examples, in the case of an inter-DU LTM cell switch, the source cell (e.g., the source DU) can determine the TCI state (e.g., based at least in part on LTM configured L1 measurement reporting) for the UE to use on the target cell when the LTM switch is triggered. The source cell (e.g., the source DU) may notify the UE (e.g., via an indication in the LTM MAC-CE cell switch command) regarding which beam to use when the UE switches to the target cell. In such examples, once the source DU determines to trigger the LTM cell switch and determines the TCI state for the UE to use on the target cell, the source DU may need to notify the target DU about the TCI information (e.g., the TCI state to be used by the UE) and may additionally need to wait for the target DU to confirm the TCI information, prior to the UE transmitting an uplink communication to the target DU (e.g., via the target cell) using the TCI state. Such backhaul communications between the source DU and the target DU may result in backhaul latency. Such backhaul latency may delay the execution of the LTM cell switch, which may result in reduced throughput, BFD, and/or RLF.

Some techniques and apparatuses described herein enable a first network node (e.g., a source DU) to transmit, and a UE to receive, configuration information indicating an LTM candidate cell or CG associated with a second network node (e.g., a target DU). The configuration information may further indicate a configuration, for the LTM candidate cell or CG, of respective uplink resources associated with a plurality of TCI states. The UE may transmit, and the first network node may receive, an L1 measurement report indicating one or more L1 measurements associated with the LTM candidate cell or CG. The first network node may transmit, and the second network node may receive, an indication of a TCI group associated with the LTM candidate cell or CG. The TCI group may include one or more candidate TCI states, of the plurality of TCI states, for the LTM candidate cell or cell group. The second network node may monitor uplink resources associated with the one or more candidate TCI states of the TCI group. The UE may receive, from the first network node, a cell switch command (e.g., a MAC-CE) triggering LTM (e.g., an LTM cell switch) to the LTM candidate cell or CG, and the cell switch command may indicate a TCI state, of the plurality of TCI states, to be used for the LTM candidate cell or CG. The UE may transmit, to the second network node via the candidate cell or CG, an uplink communication on an uplink resource associated with the TCI state. The second network node, based at least in part on monitoring the uplink resources associated with the one or more candidate TCI states of the TCI group, may receive the uplink communication. As a result, backhaul delay associated with the first network node (e.g., the source DU) notifying the second network node (e.g., the target DU) of the TCI information for the UE once the LTM determination is made may be avoided or reduced, resulting in increased throughput, decreased BFD, and/or decreased RLF.

As indicated above, FIG. 5 is provided as an example. Other examples may differ from what is described with respect to FIG. 5.

FIG. 6 is a diagram illustrating an example 600 associated with CG TCI management for inter-DU LTM, in accordance with the present disclosure. As shown in FIG. 6, example 600 includes a first DU 330-1 (e.g., a first network node), a second DU 330-2 (e.g., a second network node), and a CU 310 (e.g., a third network node). Example 600 further includes a first UE 120-1, a second UE 120-2, and a third UE 120-3 (collectively referred to as UEs 120). The first DU 330-1 may be associated with a first cell group (CG0) and the second DU 330-2 may be associated with a second cell group (CG1). In some examples, each of the DUs (e.g., the first DU 330-1 and the second DU 330-2) may serve one or more cells. A UE connecting to a DU can be configured with a set of serving cells that is a subset of the cells served by the DU. Two UEs connecting to the same DU can be configured with the same subset of serving cells, partially overlapping subsets of serving cells, or different subsets of serving cells. As shown in FIG. 6, CG0 may be a serving CG for the UEs 120 and CG1 may be an LTM candidate CG configured for the UEs 120. Accordingly, in example 600, the first DU 330-1 (or the first network node) may be a source DU associated with the serving cell or CG (e.g., CG0) for the UEs 120, and the second DU 330-2 (or second network node) may be a target DU associated with a candidate or target cell or CG (e.g., CG0) for one or more of the UEs 120. In other examples, a first DU (or first network node) may be a source DU, and a second DU (or second network node) may be a target DU.

In some aspects, the UEs 120 may be configured with a configuration of CG0 and a configuration of CG1. For example, the first DU 330-1 may transmit, to each of the first UE 120-1, the second UE 120-2, and the third UE 120-3, configuration information (e.g., an LTM configuration) indicating one or more candidate cells and/or CGs, including CG1. For example, the configuration information (e.g., the LTM configuration) may be included in an RRC message, which may be initiated from the first DU 330-1 or from the CU 310. In some examples, the configuration information may include a respective LTM candidate configuration (e.g., a respective CG configuration) for each of one or more candidate CGs (e.g., including CG1). The candidate cells/CGs are cells/CGs that are candidates to be target cells/CGs for an LTM cell switch (e.g., candidates to become serving cells/CGs for one or more of the UEs 120). In some aspects, the first UE 120-1, the second UE 120-2, and the third UE 120-3 may be or may be included in a group of UEs that are configured with the same LTM candidate cells/CGs.

In some aspects, the configuration transmitted to each of the UEs 120 (e.g., from the first DU 330-1) may indicate a configuration, for the CG1 (e.g., for the LTM candidate CG associated with the second DU 330-2), of respective uplink resources that are associated with a plurality of TCI states. For example, the configuration information may indicate, for an LTM candidate CG (e.g., CG1) or an LTM candidate cell, correspondences between TCI states and uplink resources associated with the TCI states. In some aspects, the uplink resources may be configured grant resources associated with different TCI states. In some aspects, the uplink resources may be scheduling request (SR) resources or sounding reference signal (SRS) resources associated with different TCI states. In some examples, the correspondences between the uplink resources (e.g., the configured grant, SR, or SRS resources) and the TCI states may be configured per LTM candidate CG. For example, in FIG. 6, the UEs 120 may be configured with uplink resources associated with different TCI states for CG1. In some examples, the correspondences between the uplink resources and the TCI states may be configured per LTM candidate cell. In some aspects, a group of UEs (e.g., the first UE 120-1, the second UE 120-2, and the third UE 120-3 in FIG. 6) may be configured with the same correspondences between the uplink resources and the TCI states for the same LTM candidate cell or CG.

As shown in FIG. 6, and by reference number 605, first DU 330-1 may receive L1 measurement reports for CG1. Each UE 120 (e.g., the first UE 120-1, the second UE 120-2, and the third UE 120-3) may perform L1 measurements (e.g., L1 RSRP measurements, L1 RSRQ measurements, and/or L1 signal-to-interference-plus-noise (SINR) measurements, among other examples), and each UE 120 (e.g., the first UE 120-1, the second UE 120-2, and the third UE 120-3) may transmit, to the first DU 330-1, one or more L1 measurement reports including the L1 measurements. For example, the UEs 120 may transmit the L1 measurement reports based on or otherwise associated with the configuration information indicating the LTM candidate CG (e.g., CG1).

As further shown in FIG. 6, and by reference number 610, the first DU 330-1 may transmit, and the second DU 330-2 may receive, an indication of a candidate TCI group associated with CG1. In some examples, the first DU 330-1 may transmit the indication of the candidate TCI group to the second DU 330-2 via the CU 310. For example, there may be no direct interface between the first DU 330-1 and the second DU 330-2, and the first DU 330-1 and the second DU 330-2 may communicate with each other via the CU 310. In such examples, the message transmitted from the first DU 330-1 to the CU 310 may include an indication of a gNB ID or an associated cell ID, and the CU 310 may resolve the identity of the second DU 330-2 to which the message is to be forwarded based on or otherwise in associated with the gNB ID or the associated cell ID. The TCI candidate group may include a set of candidate TCI states (e.g., one or more candidate TCI states) for CG1. In some examples, the message in which the TCI group is indicated may use UE-associated or non-UE-associated signaling. In some examples, the message in which the TCI group is indicated may or may not include the ID(s) of the UE(s) associated with the indication of the TCI group. The candidate TCI states, included in the TCI group, are candidates for TCI states that may be used by one or more UEs in a group of UEs (e.g., the UEs 120) to communicate with the second DU 330-2 for an LTM cell switch to CG1. The TCI group may be defined per LTM candidate cell or per LTM candidate CG. That is, the first DU 330-1 (e.g., the source DU) may indicate the TCI group per LTM candidate cell or LTM candidate CG associated with the second DU 330-2, not per UE being served by the first DU 330-1. For example, in a case in which the TCI group is defined per LTM candidate CG, the first DU 330-1 may transmit, to the second DU 330-2, an indication of a respective TCI group for each of one or more LTM candidate CGs associated with the second DU 330-2. In another example, in a case in which the TCI group is defined per LTM candidate cell, the first DU 330-1 may transmit, to the second DU 330-2, an indication of a respective TCI group for each of one or more LTM candidate cells (e.g., in one or more CGs) associated with the second DU 330-2.

In some aspects, the TCI group for a candidate cell/CG (e.g., the TCI group for CG1) may include a set of likely/good TCI states for a group of UEs (e.g., the UEs 120) for the candidate cell/CG. For example, the first DU 330-1 may determine a set of likely TCI states for the UEs 120 for CG1 (e.g., TCI states most likely to be used by the group of UEs to communicate via CG1) based at least in part on the L1 measurement reports received from the UEs 120. In some aspects, the first DU 330-1 may transmit the indication of the TCI group for CG1 to the second DU 330-2 prior to an LTM decision associated with any of the UEs 120 (e.g., prior to a determination to trigger LTM to CG1 for any of the UEs 120). In some aspects, the first DU 330-1 may provide continuous or periodic updates of the TCI group for an LTM candidate cell/CG. For example, the first DU 330-1 may periodically transmit the indication of the TCI group for CG1 to the second DU 330-2 with a certain periodicity. Additionally, or alternatively, the first DU 330-1 may determine (e.g., based at least in part on the L1 measurement reports) when there is an update to the candidate TCI states in the TCI group for CG1, and the first DU 330-1 may transmit the indication of the TCI group (e.g., including the updated candidate TCI states) for CG1 to the second DU 330-2 responsive to determining that there is an update to the candidate TCI states in the TCI group. In such examples in which the second DU 330-2 receives the indication of the TCI group for CG1 periodically and/or in connection with an update to the candidate TCI states, the second DU 330-2 may continuously monitor the uplink resources associated with the candidate TCI states included in the TCI group for CG1. In this case, the second DU 330-2 may switch which uplink resources to monitor in connection with an update to the candidate TCI states included in the TCI group.

In some aspects, the first DU 330-1 may proactively notify the first DU 330-1 of the TCI group for the CG1 in connection with a prediction of a potential upcoming LTM cell switch to the CG1 for any UE in the group of UEs (e.g., the UEs 120). For example, the first DU 330-1 may transmit, to the second DU 330-2, an aperiodic indication of the TCI group for CG1 responsive to detection, by the first DU 330-1, of a TCI group notification triggering condition associated with a potential LTM cell switch for at least one of the UEs 120. In this case, the TCI group notification triggering condition may be a condition that is detected by the first DU 330-1 prior to a determination to trigger the LTM cell switch for a UE. For example, the TCI group notification triggering condition may be indicative of a potential upcoming LTM cell that may be triggered, but in some cases, the TCI group notification triggering condition may be detected without a corresponding LTM cell switch being triggered. In some aspects, the first DU 330-1 may detect the TCI group notification triggering condition based at least in part on the L1 measurements included in the L1 measurement reports received from the UEs 120. In some examples, the TCI group notification triggering condition may be associated with one or more thresholds for one or more L1 measurements being satisfied. In some other examples, the first DU 330-1 may apply an AI/ML model to detect the TCI group notification triggering condition. For example, the first DU 330-1 may input the L1 measurements into the AI/ML model, and the AI/ML model may predict when a likelihood of an LTM cell switch to CG1 satisfies a certain threshold. In some aspects, the second DU 330-2 may begin monitoring the uplink resources associated with the candidate TCI states included in the TCI group for CG1, responsive to receiving the indication of the TCI group. In such examples, the second DU 330-2 may monitor the uplink resources associated with the candidate TCI states included in the TCI group for CG1 for a time duration after receiving the indication of the TCI group.

As further shown in FIG. 6, and by reference number 615, the first DU 330-1 may transmit, and the first UE 120-1 may receive, an LTM MAC-CE (e.g., a cell switch command) that triggers an LTM cell switch for the first UE 120-1 from CG0 to CG1. For example, based at least in part on one or more L1 measurement reports received from the first UE 120-1, the first DU 330-1 may determine to trigger an LTM cell switch to CG1 for the first UE 120-1, and the first DU 330-1 may transmit the LTM MAC-CE responsive to the determination to trigger the LTM cell switch to CG1 for the first UE 120-1. The LTM MAC-CE may indicate an LTM candidate cell or CG (e.g., CG1) and a TCI state to be used by the first UE 120-1 for the LTM candidate cell or CG. In some aspects, the TCI state indicated in the LTM MAC-CE may be a TCI state of the plurality of TCI states for which the first UE 120-1 is configured with respective uplink resources for CG1. In some aspects, the TCI state indicated in the LTM MAC-CE may also be one of the candidate TCI states included in the TCI group for CG1 that was provided to the second DU 330-2 from the first DU 330-1.

As further shown in FIG. 6, and by reference number 620, the first UE 120-1 may transmit, to the second DU 330-2 via CG1 (e.g., via a cell of CG1), an uplink communication using the TCI state indicated in the LTM MAC-CE (e.g., an included in the TCI state group for CG1). The first UE 120-1 may transmit the uplink communication via an uplink resource (e.g., a configured grant resource, an SR resource, or an SRS resource) associated with the TCI state. The uplink communication may be an uplink communication associated with establishing a connection on CG1 to complete the LTM cell switch to CG1. For example, the uplink communication may include a MAC-CE that identifies the first UE 120-1 in the target cell. In some examples, the uplink communication may be an RRC reconfiguration complete message. The second DU 330-2 may monitor the uplink resources associated with the candidate TCI states in the TCI group for CG1. In some aspects, based at least in part on monitoring the uplink resource associated with the TCI state used by the first UE 120-1 for transmitting the uplink communication (e.g., because the TCI state is included in the TCI group for CG1), the second DU 330-2 may receive the uplink transmission transmitted by the first UE 120-1. In some aspects, the second DU 330-2 may identify which UE of the UEs transmitted the uplink communication, as described elsewhere herein. In some aspects, although multiple UEs 120 may be configured with the same uplink resources for CG1, the first DU 330-1 may prevent collisions on the configured uplink resources by refraining from triggering LTM for UEs that will use colliding uplink resources simultaneously.

As indicated above, FIG. 6 is provided as an example. Other examples may differ from what is described with respect to FIG. 6.

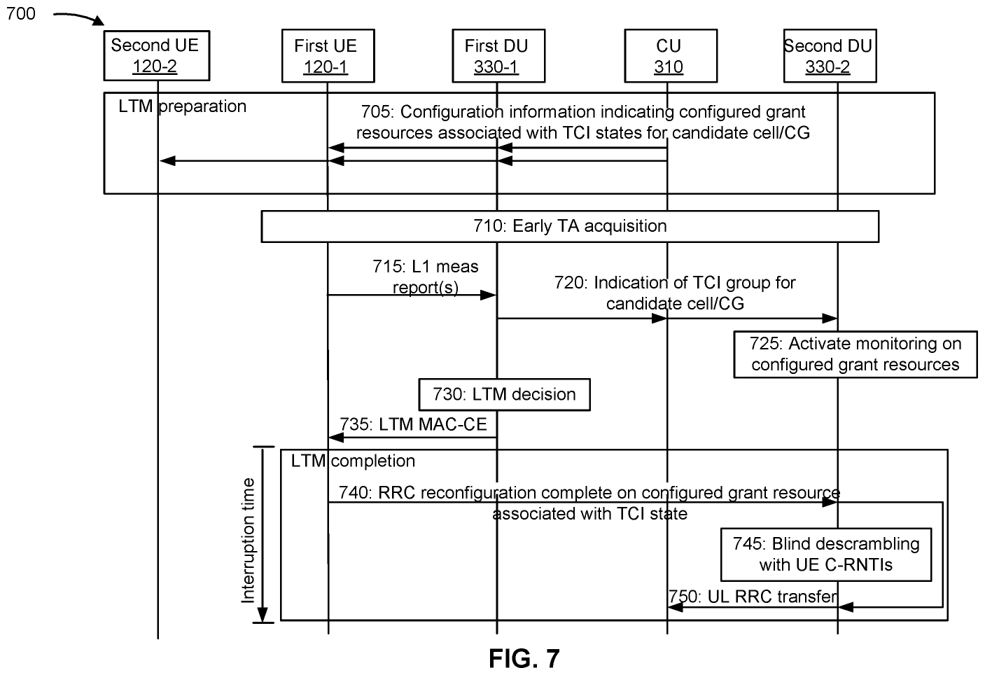

FIG. 7 is a diagram illustrating an example 700 associated with CG TCI management for inter-DU LTM, in accordance with the present disclosure. As shown in FIG. 7, example 700 includes a first DU 330-1 (e.g., a first network node), a second DU 330-2 (e.g., a second network node), a CU 310 (e.g., a third network node), a first UE 120-1, and a second UE 120-2. The first UE 120-1 and the second UE 120-2 may be collectively referred to as UEs 120. The first DU 330-1 may be a source DU associated with the serving cell or CG for the UEs 120, and the second DU 330-2 may be a target DU associated with a candidate or target cell or CG for one or more of the UEs 120. In other examples, a first DU (or first network node) may be a source DU, and a second DU (or second network node) may be a target DU.

As shown in FIG. 7, and by reference number 705, in an LTM preparation phase, the first UE 120-1 and the second UE 120-2 may each receive, from the first DU 330-1, configuration information (e.g., LTM configuration information). For example, the CU 310 may determine the configuration information for the first UE 120-1 and the second UE 120-2, and the CU 310 may transmit the configuration information for the first UE 120-1 and the second UE 120-2 to the first DU 330-1. The first DU 330-1 may receive the configuration information from the CU 310, and the first DU 330-1 may transmit the configuration information to the first UE 120-1 and the second UE 120-2.

In some aspects, the configuration information may indicate an LTM candidate cell or CG associated with the second DU 330-2. In some aspects, the configuration information may indicate a configuration, for the LTM candidate cell or CG, of respective configured grant resources that are associated with a plurality of TCI states. For example, the configuration information may indicate a respective configured grant resource per TCI state (for each of a plurality of TCI states) for the LTM candidate cell or CG. The configuration information may indicate correspondences between the TCI states and the configured grant resources. In some aspects, the configuration information may configure overloaded periodic configured grant resources for the LTM candidate cell or CG for a group of UEs (e.g., including the first UE 120-1 and the second UE 120-2). That is, the configuration information may configure the group of UEs (e.g., including the first UE 120-1 and the second UE 120-2) with the same configured grant resources (e.g., periodic uplink resources) and the same correspondences between the TCI states and the configured grant resources, for the LTM candidate cell or CG.

In some aspects, the configuration information may indicate a plurality of LTM candidate cells, including one or more LTM candidate cells associated with the second DU 330-2, and the configuration information may indicate a respective configuration of configured grant resources associated with the TCI states for each of the plurality of LTM candidate cells. In such examples, the correspondences between the configured grant resources and the TCI states may be configured per LTM candidate cell. That is, the configuration information may indicate a configured grant resource per TCI state (for each of the plurality of TCI states) per LTM candidate cell. In some aspects, the configuration information may indicate a plurality of LTM candidate CGs, including one or more LTM candidate CGs associated with the second DU 330-2, and the configuration information may indicate a respective configuration of configured grant resources associated with the TCI states for each of the plurality of LTM candidate CGs. In such examples, the correspondences between the configured grant resources and the TCI states may be configured per LTM candidate CG. That is, the configuration information may indicate a configured grant resource per TCI state (for each of the plurality of TCI states) per LTM candidate CG.

As further shown in FIG. 7, and by reference number 710, the first UE 120-1 may perform early TA acquisition with the candidate cell or CG associated with the second DU 330-2. For example, during an early synchronization phase, the UE 120 may perform downlink synchronization and TA acquisition with one or more candidate target cells, including the candidate cell associated with second DU 330-2, prior to receiving an LTM switch command (e.g., an LTM MAC-CE).

As further shown in FIG. 7, and by reference number 715, the first UE 120-1 may transmit, and the first DU 330-1 may receive, one or more L1 measurement reports for the candidate cell or CG associated with the second DU 330-2. For example, the first UE 120-1 may transmit periodic L1 measurement reports for the candidate cell or CG to the first DU 330-1, and/or the first UE 120-1 may transmit L1 measurement reports in connection with one or more mobility conditions being satisfied. The L1 measurement reports may include L1 measurements (e.g., L1 RSRP measurements, L1 RSRQ measurements, and/or L1 SINR measurements, among other examples) of the candidate cell or CG performed by the first UE 120-1. Although the transmission of the L1 measurement reports by the first UE 120-1 is shown after the early TA acquisition (shown by reference number 710), in some examples, the first UE 120-1 may transmit one or more L1 measurement reports to the first DU 330-1 prior to the early TA acquisition. Additionally, or alternatively, although the transmission of the L1 measurement reports by the first UE 120-1 is shown prior to the transmission of the indication of the TCI group by the first DU 330-1 (shown by reference number 720), in some examples, the first UE 120-1 may transmit one or more L1 measurement reports to the first DU 330-1 after the first DU 330-1 transmits the indication of the TCI group to the second DU 330-2.

As further shown in FIG. 7, and by reference number 720, the first DU 330-1 may transmit, and the second DU 330-2 may receive, an indication of a TCI group associated with the LTM candidate cell or CG associated with the second DU 330-2. For example, the first DU 330-1 may transmit the indication of the candidate TCI group to the second DU 330-2 via the CU 310. That is, the first DU 330-1 may transmit the indication of the TCI group to the CU 310, the CU 310 may receive the indication of the TCI group and transmit the indication of the TCI group to the second DU 330-2, and the second DU 330-2 may receive the indication of the TCI group from the CU 310. The TCI candidate group may include a set of candidate TCI states (e.g., one or more candidate TCI states) for the LTM candidate cell or CG associated with the second DU 330-2. The candidate TCI states, included in the TCI group, are candidates for TCI states that may be used by one or more UEs in a group of UEs (e.g., including the first UE 120-1 and the second UE 120-2) to communicate with the second DU 330-2 for an LTM cell switch to the candidate cell or CG associated with the second DU 330-2.

In some aspects, the TCI group may be defined per LTM candidate cell or per LTM candidate CG. In some examples, there may be multiple candidate CGs associated with the second DU 330-2 that are configured for one or more groups of UEs being served by a serving cell associated with the first DU 330-1, and the first DU 330-1 may transmit, to the second DU 330-2, an indication of a respective TCI group for each LTM candidate CG associated with the second DU 330-2. In this case, the TCI group for each LTM candidate CG may include candidate TCI states associated with that LTM candidate CG for a group of UEs configured with that LTM candidate CG. In some other examples, there may be multiple candidate cells (e.g., in one or more CGs) associated with the second DU 330-2 that are configured for one or more groups of UEs being served by a serving cell associated with the first DU 330-1, and the first DU 330-1 may transmit, to the second DU 330-2, an indication of a respective TCI group for each LTM candidate cell associated with the second DU 330-2. In this case, the TCI group for each LTM candidate cell may include candidate TCI states associated with that LTM candidate cell for a group of UEs configured with that LTM candidate cell.

In some aspects, the TCI group for the candidate cell/CG associated with the second DU 330-2 may include a set of likely/good TCI states for a group of UEs (e.g., including the first UE 120-1 and the second UE 120-2) for the candidate cell/CG. For example, the first DU 330-1 may determine a set of likely TCI states for the group of UEs for the cell/CG associated with the second DU 330-2 (e.g., TCI states most likely to be used by the group of UEs to communicate via the cell/CG) based at least in part on the L1 measurement reports received from the UEs in the group of UEs. In some aspects, the first DU 330-1 may transmit the indication of the TCI group for CG1 to the second DU 330-2 prior to an LTM decision associated with any of the UEs in the group of UEs (e.g., prior to the LTM decision shown by reference number 730). In some aspects, the first DU 330-1 may provide continuous or periodic updates of the TCI group for an LTM candidate cell/CG. For example, the first DU 330-1 may periodically transmit the indication of the TCI group for CG1 to the second DU 330-2 with a certain periodicity. Additionally, or alternatively, the first DU 330-1 may determine (e.g., based at least in part on the L1 measurement reports) when there is an update to the candidate TCI states in the TCI group for CG1, and the first DU 330-1 may transmit the indication of the TCI group (e.g., including the updated candidate TCI states) for CG1 to the second DU 330-2 responsive to determining that there is an update to the candidate TCI states in the TCI group.

In some aspects, the first DU 330-1 may proactively notify the first DU 330-1 of the TCI group for the CG1 in connection with a prediction of a potential upcoming LTM cell switch to the CG1 for any UE in the group of UEs (e.g., the UEs 120). For example, the first DU 330-1 may transmit, to the second DU 330-2, an aperiodic indication of the TCI group for CG1 responsive to detection, by the first DU 330-1, of a TCI group notification triggering condition associated with a potential LTM cell switch for at least one of the UEs 120. In this case, the TCI group notification triggering condition may be a condition that is detected by the first DU 330-1 prior to a determination to trigger the LTM cell switch for a UE. For example, the TCI group notification triggering condition may be indicative of a potential upcoming LTM cell switch that may be triggered. In some aspects, the first DU 330-1 may detect the TCI group notification triggering condition based at least in part on the L1 measurements included in the L1 measurement reports received from the UEs in the group of UEs (e.g., including the first UE 120-1 and the second UE 120-2). In some examples, the TCI group notification triggering condition may be associated with one or more thresholds for one or more L1 measurements being satisfied. In some other examples, the first DU 330-1 may apply an AI/ML model to detect the TCI group notification triggering condition based at least in part on the L1 measurements.

As further shown in FIG. 7, and by reference number 725, the second DU 330-2 may activate monitoring on the configured grant resources associated with the candidate TCI states included in the TCI group for the LTM candidate cell or CG associated with the second DU 330-2. The second DU 330-2 may store the configuration of the configured grant resources associated with the plurality of TCI states for the LTM candidate cell or CG associated with the second DU 330-2. For example, the CU 310 may transmit, and the second DU 330-2 may receive, configuration information indicating the configuration of the associations between the configured grant resources and the TCI states for the LTM candidate cell or CG. In some aspects, the second DU 330-2 may active monitoring the configured grant resources associated with the candidate TCI states included in the TCI state group for the LTM candidate cell or CG based at least in part on receiving the indication of the TCI state group.

In some aspects, such as in examples in which the second DU 330-2 receives the indication of the TCI group periodically and/or in connection with updates to the candidate TCI states included in the TCI group, the second DU 330-2 may continuously monitor the configured grant resources associated with the candidate TCI states included in the TCI group for the LTM candidate cell or CG. For example, the second DU 330-2 may activate monitoring the configured grant resources during the LTM preparation phase and/or in connection with receiving a first indication of the TCI group for the LTM candidate cell or CG. In this case, the second DU 330-2 may switch which configured grant resources to monitor in connection with an indication of the TCI group for the LTM candidate cell or CG that updates the candidate TCI states included in the TCI group.

In some aspects, such as in examples in which the first DU 330-1 transmits the indication of the TCI group to the second DU 330-2 in connection with the TCI group notification triggering condition being satisfied, the second DU 330-2 may begin monitoring the configured grant associated with the candidate TCI states included in the TCI group for CG1, responsive to receiving the indication of the TCI group. In such examples, the second DU 330-2 may monitor the configured grant resources associated with the candidate TCI states included in the TCI group for CG1 for a time duration after receiving the indication of the TCI group.

As further shown in FIG. 7, and by reference number 730, based at least in part on the L1 measurement reports received from the first UE 120-1, the first DU 330-1 may decide to trigger an LTM cell switch for the first UE 120-1 from the serving cell associated with the first DU 330-1 to a target cell or CG. For example, the first DU 330-1 may determine that the target cell or CG for the LTM cell switch for the first UE 120-1 is the candidate cell or CG associated with the second DU 330-2.

As further shown in FIG. 7, and by reference number 735, the first DU 330-1 may transmit, and the first UE 120-1 may receive, an LTM MAC-CE (e.g., an LTM cell switch command) triggering an LTM cell switch to the LTM candidate cell or CG (e.g., the target cell or CG) associated with the second DU 330-2. The LTM MAC-CE may include an indication of a candidate configuration index associated with the target cell. For example, the candidate configuration index may correspond to a candidate configuration index associated with the LTM candidate cell or CG associated with the second DU 330-2. In some aspects, the LTM MAC-CE may indicate a TCI state to be used by the first UE 120-1 for the LTM candidate cell or CG. In some aspects, the TCI state indicated in the LTM MAC-CE may be a TCI state of the plurality of TCI states for which the first UE 120-1 is configured with respective configured grant resources for the LTM candidate cell or CG. In some aspects, the TCI state indicated in the LTM MAC-CE may also be one of the candidate TCI states included in the TCI group for the LTM candidate cell or CG that was indicated to the second DU 330-2 from the first DU 330-1.

As further shown in FIG. 7, and by reference number 740, in the LTM completion phase, the first UE 120-1 may transmit, to the second DU 330-2 via the candidate cell or CG (e.g., the target cell or CG) indicated in the LTM MAC-CE, an uplink communication on a configured grant resource associated with the TCI state indicated in the LTM MAC-CE. The first UE 120-1 may transmit the uplink communication using the TCI state indicated in the LTM MAC-CE. The uplink communication may be associated with the LTM cell switch to the LTM candidate cell or CG associated with the second DU 330-2. In some aspects, as shown in FIG. 7, the uplink communication may be an RRC reconfiguration complete message. For example, the RRC reconfiguration compete message may indicate completion of the LTM cell switch.

In some aspects, the second DU 330-2 may receive the uplink communication (e.g., the RRC reconfiguration complete message) based at least in part on monitoring the configured grant resources associated with the candidate TCI states included in the TCI group for the LTM candidate cell or CG. For example, the second DU 330-2 may monitor the configured grant resource associated with the TCI state indicated in the LTM MAC-CE based at least in part on the TCI state indicated in the LTM MAC-CE being one of the candidate TCI states included in the TCI group for the LTM candidate cell or CG.

As discussed above in connection with reference number 705, a group of UEs (e.g., including the first UE 120-1 and the second UE 120-2) may be configured with the same configured grant resources associated with the TCI states for the LTM candidate cell or CG. Accordingly, the second DU 330-2 may receive an uplink communication from any of the UEs in the group of UEs on a configured grant resource associated with a candidate LTM state in the TCI group for the LTM candidate cell or CG. In some aspects, the second DU 330-2 may identify which UE has performed access as part of the LTM cell switch (e.g., which UE has transmitted the uplink communication) based on a UE-specific cell radio network temporary identifier (C-RNTI) associated with the UE that transmits the uplink communication (e.g., the RRC reconfiguration complete message). In some aspects, the first UE 120-1 may scramble the uplink data included in the configured grant uplink communication using the UE-specific C-RNTI associated with the first UE 120-1. In some aspects, the first UE 120-1 may include an explicit indication of the C-RNTI associated with the first UE 120-1 in a MAC-CE included in configured grant uplink communication when accessing the target cell (e.g., the LTM candidate cell or CG).

As further shown in FIG. 7, and by reference number 745, the second DU 330-2 may perform blind descrambling with C-RNTIs associated with the group of UEs (e.g., including the first UE 120-1 and the second UE 120-2) to decode the uplink communication (e.g., the RRC reconfiguration complete message). In some aspects, the C-RNTI that successfully descrambles the uplink communication (e.g., the C-RNTI associated with the first UE 120-1) may identify the UE (e.g., the first UE 120-1) that transmitted the uplink communication (e.g., the UE that has performed access as part of the LTM cell switch). Additionally, or alternatively, the second DU 330-2 may identify the UE that transmitted the uplink communication based at least in part on an explicit indication of the C-RNTI associated with the first UE 120-1 in the MAC-CE included in the uplink communication.

As further shown in FIG. 7, and by reference number 750, the second DU 330-2 may transmit, and the CU 310 may receive, an uplink RRC message transfer message. For example, once the second DU 330-2 receives and decodes the RRC reconfiguration complete message, the second DU 330-2 may encapsulate the RRC reconfiguration complete message in the uplink RRC message transfer message, and transmit the uplink RRC message transfer message to the CU 310. The RRC message transfer message may be indicative of completion of the LTM cell switch for the first UE 120-1. As shown in FIG. 7, an interrupt time associated with the LTM cell switch does not include latency associated with backhaul communications to notify the second DU 330-2 of the TCI information included in the LTM MAC-CE.

As indicated above, FIG. 7 is provided as an example. Other examples may differ from what is described with respect to FIG. 7.

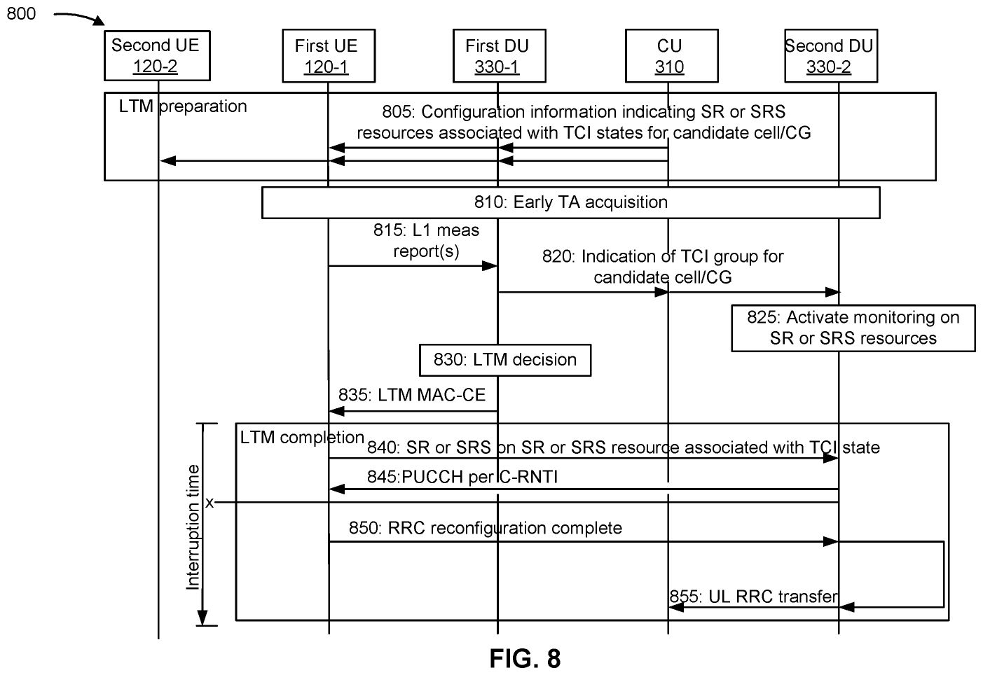

FIG. 8 is a diagram illustrating an example 800 associated with CG TCI management for inter-DU LTM, in accordance with the present disclosure. As shown in FIG. 8, example 800 includes a first DU 330-1 (e.g., a first network node), a second DU 330-2 (e.g., a second network node), a CU 310 (e.g., a third network node), a first UE 120-1, and a second UE 120-2. The first UE 120-1 and the second UE 120-2 may be collectively referred to as UEs 120. The first DU 330-1 may be a source DU associated with the serving cell or CG for the UEs 120, and the second DU 330-2 may be a target DU associated with a candidate or target cell or CG for one or more of the UEs 120. In other examples, a first DU (or first network node) may be a source DU, and a second DU (or second network node) may be a target DU.

As shown in FIG. 8, and by reference number 805, in an LTM preparation phase, the first UE 120-1 and the second UE 120-2 may each receive, from the first DU 330-1, configuration information (e.g., LTM configuration information). For example, the CU 310 may determine the configuration information for the first UE 120-1 and the second UE 120-2, and the CU 310 may transmit the configuration information for the first UE 120-1 and the second UE 120-2 to the first DU 330-1. The first DU 330-1 may receive the configuration information from the CU 310, and the first DU 330-1 may transmit the configuration information to the first UE 120-1 and the second UE 120-2.

In some aspects, the configuration information may indicate an LTM candidate cell or CG associated with the second DU 330-2. In some aspects, the configuration information may indicate a configuration, for the LTM candidate cell or CG, of respective SR or SRS resources that are associated with a plurality of TCI states. For example, the configuration information may indicate a respective SR or SRS resource per TCI state (for each of a plurality of TCI states) for the LTM candidate cell or CG. The configuration information may indicate correspondences between the TCI states and the configured grant resources. In some aspects, the configuration information may configure overloaded periodic SR or SRS resources for the LTM candidate cell or CG for a group of UEs (e.g., including the first UE 120-1 and the second UE 120-2). That is, the configuration information may configure the group of UEs (e.g., including the first UE 120-1 and the second UE 120-2) with the same SR or SRS resources (e.g., periodic uplink resources for SR or SRS transmission) and the same correspondences between the TCI states and the SR or SRS resources, for the LTM candidate cell or CG.

In some aspects, the configuration information may configure frequency division multiplexing (FDM) partitioning of the SR or SRS resources associated with the TCI states for the LTM candidate cell or CG associated with the second DU 330-2. For example, the configuration information may indicate different frequency parts of the SR or SRS resources associated with different UEs. For example, the configuration information may indicate a first frequency part of the SR or SRS resources associated with the first UE 120-1 and a second frequency part of the SR or SRS resources associated with the second UE 120-2.

In some aspects, such as in the case of a multi-user multiple-input multiple-output (MU-MIMO) capable network node, a same set of time or frequency uplink resources (e.g., SR or SRS resources) may be configured corresponding to different TCI states for different UEs or groups of UEs. For example, the first DU 330-1 may transmit, to one or more first UEs (e.g., a first UE or a first group of UEs), first configuration information indicating an association between a set of uplink resources (e.g., SR or SRS resources or configured grant resources) and a first set of TCI states, and the first DU 330-1 may transmit, to one or more second UEs (e.g., a second UE or a second group of UEs), second configuration information indicating an association between the set of uplink resources and a second set of TCI states.

In some aspects, the configuration information may indicate a plurality of LTM candidate cells, including one or more LTM candidate cells associated with the second DU 330-2, and the configuration information may indicate a respective configuration of SR or SRS resources associated with the TCI states for each of the plurality of LTM candidate cells. In such examples, the correspondences between the SR or SRS resources and the TCI states may be configured per LTM candidate cell. That is, the configuration information may indicate an SR or SRS resource per TCI state (for each of the plurality of TCI states) per LTM candidate cell. In some aspects, the configuration information may indicate a plurality of LTM candidate CGs, including one or more LTM candidate CGs associated with the second DU 330-2, and the configuration information may indicate a respective configuration of SR or SRS resources associated with the TCI states for each of the plurality of LTM candidate CGs. In such examples, the correspondences between the SR or SRS resources and the TCI states may be configured per LTM candidate CG. That is, the configuration information may indicate an SR or SRS resource per TCI state (for each of the plurality of TCI states) per LTM candidate CG.

As further shown in FIG. 8, and by reference number 810, the first UE 120-1 may perform early TA acquisition with the candidate cell or CG associated with the second DU 330-2. For example, during an early synchronization phase, the UE 120 may perform downlink synchronization and TA acquisition with one or more candidate target cells, including the candidate cell associated with second DU 330-2, prior to receiving an LTM switch command (e.g., an LTM MAC-CE).

As further shown in FIG. 8, and by reference number 815, the first UE 120-1 may transmit, and the first DU 330-1 may receive, one or more L1 measurement reports for the candidate cell or CG associated with the second DU 330-2. For example, the first UE 120-1 may transmit periodic L1 measurement reports for the candidate cell or CG to the first DU 330-1, and/or the first UE 120-1 may transmit L1 measurement reports in connection with one or more mobility conditions being satisfied. The L1 measurement reports may include L1 measurements (e.g., L1 RSRP measurements, L1 RSRQ measurements, and/or L1 SINR measurements, among other examples) of the candidate cell or CG performed by the first UE 120-1. Although the transmission of the L1 measurement reports by the first UE 120-1 is shown after the early TA acquisition (shown by reference number 810), in some examples, the first UE 120-1 may transmit one or more L1 measurement reports to the first DU 330-1 prior to the early TA acquisition. Additionally, or alternatively, although the transmission of the L1 measurement reports by the first UE 120-1 is shown prior to the transmission of the indication of the TCI group by the first DU 330-1 (shown by reference number 820), in some examples, the first UE 120-1 may transmit one or more L1 measurement reports to the first DU 330-1 after the first DU 330-1 transmits the indication of the TCI group to the second DU 330-2.

As further shown in FIG. 8, and by reference number 820, the first DU 330-1 may transmit, and the second DU 330-2 may receive, an indication of a TCI group associated with the LTM candidate cell or CG associated with the second DU 330-2. For example, the first DU 330-1 may transmit the indication of the candidate TCI group to the second DU 330-2 via the CU 310. That is, the first DU 330-1 may transmit the indication of the TCI group to the CU 310, the CU 310 may receive the indication of the TCI group and transmit the indication of the TCI group to the second DU 330-2, and the second DU 330-2 may receive the indication of the TCI group from the CU 310. The TCI candidate group may include a set of candidate TCI states (e.g., one or more candidate TCI states) for the LTM candidate cell or CG associated with the second DU 330-2. The candidate TCI states, included in the TCI group, are candidates for TCI states that may be used by one or more UEs in a group of UEs (e.g., including the first UE 120-1 and the second UE 120-2) to communicate with the second DU 330-2 for an LTM cell switch to the candidate cell or CG associated with the second DU 330-2.

In some aspects, the TCI group may be defined per LTM candidate cell or per LTM candidate CG. In some examples, there may be multiple candidate CGs associated with the second DU 330-2 that are configured for one or more groups of UEs being served by a serving cell associated with the first DU 330-1, and the first DU 330-1 may transmit, to the second DU 330-2, an indication of a respective TCI group for each LTM candidate CG associated with the second DU 330-2. In this case, the TCI group for each LTM candidate CG may include candidate TCI states associated with that LTM candidate CG for a group of UEs configured with that LTM candidate CG. In some other examples, there may be multiple candidate cells (e.g., in one or more CGs) associated with the second DU 330-2 that are configured for one or more groups of UEs being served by a serving cell associated with the first DU 330-1, and the first DU 330-1 may transmit, to the second DU 330-2, an indication of a respective TCI group for each LTM candidate cell associated with the second DU 330-2. In this case, the TCI group for each LTM candidate cell may include candidate TCI states associated with that LTM candidate cell for a group of UEs configured with that LTM candidate cell.

In some aspects, the TCI group for the candidate cell/CG associated with the second DU 330-2 may include a set of likely/good TCI states for a group of UEs (e.g., including the first UE 120-1 and the second UE 120-2) for the candidate cell/CG. For example, the first DU 330-1 may determine a set of likely TCI states for the group of UEs for the cell/CG associated with the second DU 330-2 (e.g., TCI states most likely to be used by the group of UEs to communicate via the cell/CG) based at least in part on the L1 measurement reports received from the UEs in the group of UEs. In some aspects, the first DU 330-1 may transmit the indication of the TCI group for CG1 to the second DU 330-2 prior to an LTM decision associated with any of the UEs in the group of UEs (e.g., prior to the LTM decision shown by reference number 830). In some aspects, the first DU 330-1 may provide continuous or periodic updates of the TCI group for an LTM candidate cell/CG. For example, the first DU 330-1 may periodically transmit the indication of the TCI group for CG1 to the second DU 330-2 with a certain periodicity. Additionally, or alternatively, the first DU 330-1 may determine (e.g., based at least in part on the L1 measurement reports) when there is an update to the candidate TCI states in the TCI group for CG1, and the first DU 330-1 may transmit the indication of the TCI group (e.g., including the updated candidate TCI states) for CG1 to the second DU 330-2 responsive to determining that there is an update to the candidate TCI states in the TCI group.

In some aspects, the first DU 330-1 may proactively notify the first DU 330-1 of the TCI group for the CG1 in connection with a prediction of a potential upcoming LTM cell switch to the CG1 for any UE in the group of UEs (e.g., the UEs 120). For example, the first DU 330-1 may transmit, to the second DU 330-2, an aperiodic indication of the TCI group for CG1 responsive to detection, by the first DU 330-1, of a TCI group notification triggering condition associated with a potential LTM cell switch for at least one of the UEs 120. In this case, the TCI group notification triggering condition may be a condition that is detected by the first DU 330-1 prior to a determination to trigger the LTM cell switch for a UE. For example, the TCI group notification triggering condition may be indicative of a potential upcoming LTM cell that may be triggered. In some aspects, the first DU 330-1 may detect the TCI group notification triggering condition based at least in part on the L1 measurements included in the L1 measurement reports received from the UEs in the group of UEs (e.g., including the first UE 120-1 and the second UE 120-2). In some examples, the TCI group notification triggering condition may be associated with one or more thresholds for one or more L1 measurements being satisfied. In some other examples, the first DU 330-1 may apply an AI/ML model to detect the TCI group notification triggering condition based at least in part on the L1 measurements.

As further shown in FIG. 8, and by reference number 825, the second DU 330-2 may activate monitoring on the SR or SRS resources associated with the candidate TCI states included in the TCI group for the LTM candidate cell or CG associated with the second DU 330-2. The second DU 330-2 may store the configuration of the SR or SRS resources associated with the plurality of TCI states for the LTM candidate cell or CG associated with the second DU 330-2. For example, the CU 310 may transmit, and the second DU 330-2 may receive, configuration information indicating the configuration of the associations between the SR or SRS resources and the TCI states for the LTM candidate cell or CG. In some aspects, the second DU 330-2 may activate monitoring the SR or SRS resources associated with the candidate TCI states included in the TCI state group for the LTM candidate cell or CG based at least in part on receiving the indication of the TCI state group.

In some aspects, such as in examples in which the second DU 330-2 receives the indication of the TCI group periodically and/or in connection with updates to the candidate TCI states included in the TCI group, the second DU 330-2 may continuously monitor the SR or SRS resources associated with the candidate TCI states included in the TCI group for the LTM candidate cell or CG. For example, the second DU 330-2 may activate monitoring the SR or SRS resources during the LTM preparation phase and/or in connection with receiving a first indication of the TCI group for the LTM candidate cell or CG. In this case, the second DU 330-2 may switch which SR or SRS resources to monitor in connection with an indication of the TCI group for the LTM candidate cell or CG that updates the candidate TCI states included in the TCI group.

In some aspects, such as in examples in which the first DU 330-1 transmits the indication of the TCI group to the second DU 330-2 in connection with the TCI group notification triggering condition being satisfied, the second DU 330-2 may begin monitoring the SR or SRS associated with the candidate TCI states included in the TCI group for CG1, responsive to receiving the indication of the TCI group. In such examples, the second DU 330-2 may monitor the SR or SRS resources associated with the candidate TCI states included in the TCI group for CG1 for a time duration after receiving the indication of the TCI group.

As further shown in FIG. 8, and by reference number 830, based at least in part on the L1 measurement reports received from the first UE 120-1, the first DU 330-1 may decide to trigger an LTM cell switch for the first UE 120-1 from the serving cell associated with the first DU 330-1 to a target cell or CG. For example, the first DU 330-1 may determine that the target cell or CG for the LTM cell switch for the first UE 120-1 is the candidate cell or CG associated with the second DU 330-2.

As further shown in FIG. 8, and by reference number 835, the first DU 330-1 may transmit, and the first UE 120-1 may receive, an LTM MAC-CE (e.g., an LTM cell switch command) triggering an LTM cell switch to the LTM candidate cell or CG (e.g., the target cell or CG) associated with the second DU 330-2. The LTM MAC-CE may include an indication of a candidate configuration index associated with the target cell. For example, the candidate configuration index may correspond to a candidate configuration index associated with the LTM candidate cell or CG associated with the second DU 330-2. In some aspects, the LTM MAC-CE may indicate a TCI state to be used by the first UE 120-1 for the LTM candidate cell or CG. In some aspects, the TCI state indicated in the LTM MAC-CE may be a TCI state of the plurality of TCI states for which the first UE 120-1 is configured with respective SR or SRS resources for the LTM candidate cell or CG. In some aspects, the TCI state indicated in the LTM MAC-CE may also be one of the candidate TCI states included in the TCI group for the LTM candidate cell or CG that was indicated to the second DU 330-2 from the first DU 330-1.

As further shown in FIG. 8, and by reference number 840, in the LTM completion phase, the first UE 120-1 may transmit, to the second DU 330-2 via the candidate cell or CG (e.g., the target cell or CG) indicated in the LTM MAC-CE, an uplink communication on an SR or SRS resource associated with the TCI state indicated in the LTM MAC-CE. The first UE 120-1 may transmit the uplink communication using the TCI state indicated in the LTM MAC-CE. The uplink communication may be associated with the LTM cell switch to the LTM candidate cell or CG associated with the second DU 330-2. In some aspects, as shown in FIG. 8, the uplink communication may be an SR or an SRS. For example, the first UE 120-1 may transmit an SR on an SR resource associated with the TCI state indicated in the LTM MAC-CE, or the first UE 120-1 may transmit an SRS on an SRS resource associated with the TCI state indicated in the LTM MAC-CE. The SR or the SRS may indicate, to the second DU 330-2, that a UE is accessing the LTM candidate cell or CG as part of an LTM cell switch.

In some aspects, the second DU 330-2 may receive the uplink communication (e.g., the SR or the SRS) based at least in part on monitoring the SR or SRS resources associated with the candidate TCI states included in the TCI group for the LTM candidate cell or CG. For example, the second DU 330-2 may monitor the SR or SRS resource associated with the TCI state indicated in the LTM MAC-CE based at least in part on the TCI state indicated in the LTM MAC-CE being one of the candidate TCI states included in the TCI group for the LTM candidate cell or CG.

As discussed above in connection with reference number 805, a group of UEs (e.g., including the first UE 120-1 and the second UE 120-2) may be configured with the same SR or SRS resources associated with the TCI states for the LTM candidate cell or CG. Accordingly, the second DU 330-2 may receive an SR or SRS from any of the UEs in the group of UEs on an SR or SRS resource associated with a candidate LTM state in the TCI group for the LTM candidate cell or CG. In some aspects, the second DU 330-2 may identify which UE has performed access as part of the LTM cell switch (e.g., which UE has transmitted the SR or SRS) based at least in part on an FDM of the SR or SRS resources. For example, the configuration information may identify different frequency parts associated with different UEs in the group of UEs, and the second DU 330-2 may identify which UE transmitted the SR or SRS based at least in part on the frequency part of the SR or SRS resource in which the SR or SRS is received by the second DU 330-2. For example, the first UE 120-1 may transmit the SR or SRS in a first frequency part, of the SR or SRS resource associated with the first UE 120-1, and the second DU 330-2 may identify that the first UE 120-1 transmitted the SR or SRS based at least in part on receiving the SR or the SRS in the first frequency part associated with the first UE 120-1.

In some aspects, as shown by reference number 845, based at least in part on receiving the SR or the SRS, the second DU 330-2 may transmit downlink communications (e.g., physical downlink control channel (PDCCH) communications), each including an uplink grant, and each associated with a C-RNTI associated with a respective UE of the group of UEs (e.g., the group of UEs configured with the SR or SRS resources associated with the TCI states for the LTM candidate cell or CG). That is, the second DU 330-2 may transmit a respective PDCCH communication, including an uplink grant, addressed to each C-RNTI of the C-RNTIs associated with the group of UEs. This enables the second DU 330-2 to identify the UE that transmitted the SR or SRS without UE-specific resource configurations (e.g., indicating frequency parts associated with the UEs). The UE that transmitted the SR or SRS may monitor for the PDCCH communication from the second DU 330-2 and receive the PDCCH communication addressed to the C-RNTI associated with the UE. However, the other UEs may not monitor for the PDCCH communications from the second DU 330-2, and may not receive the respective PDCCH communication addressed to the respective C-RNTI associated with each other UE. For example, the second DU 330-2 may transmit, to the first UE 120-1, a PDCCH communication addressed to a first C-RNTI associated with the first UE 120-1. The first UE 120-1 may monitor for the PDCCH communication from the second DU 330-2 based at least in part on transmitting the SR or the SRS, and the UE may receive the PDCCH communication addressed to the first C-RNTI associated with the first UE 120-1. The second DU 330-2 may transmit a PDCCH communication addressed to a second C-RNTI associated with the second UE 120-2. The second UE 120-2 may not monitor for the PDCCH communication from the second DU 330-2, and the second UE 120-2 may not receive the PDCCH communication addressed to the second C-RNTI (shown with an “x” in FIG. 8).

In some other aspects, such as in a case in which the first UE 120-1 transmits the SR or SRS in a frequency part of the SR or SRS resource associated with the first UE 120-1, the second DU 330-2 may identify that the first UE 120-1 transmitted the SR or SRs, and the second DU 330-2 may transmit only the PDCCH communication (including an uplink grant) addressed to the C-RNTI associated with the first UE 120-1.

As further shown in FIG. 8, and by reference number 850, the first UE 120-1 may transmit, and the second DU 330-2 may receive, an RRC reconfiguration complete message. In some aspects, the first UE 120-1 may transmit the RRC reconfiguration complete message based at least in part on the uplink grant in the downlink communication received from the first DU 330-1 (e.g., the PDCCH communication addressed to the C-RNTI associated with the first UE 120-1). For example, the first UE 120-1 may transmit the RRC configuration complete message in uplink resources allocated in the uplink grant included in the PDCCH communication.

As further shown in FIG. 8, and by reference number 855, the second DU 330-2 may transmit, and the CU 310 may receive, an uplink RRC message transfer message. For example, once the second DU 330-2 receives the RRC reconfiguration complete message, the second DU 330-2 may encapsulate the RRC reconfiguration complete message in the uplink RRC message transfer message, and transmit the uplink RRC message transfer message to the CU 310. The RRC message transfer message may be indicative of completion of the LTM cell switch for the first UE 120-1. As shown in FIG. 8, an interrupt time associated with the LTM cell switch does not include latency associated with backhaul communications to notify the second DU 330-2 of the TCI information included in the LTM MAC-CE.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with CG TCI management for LTM.

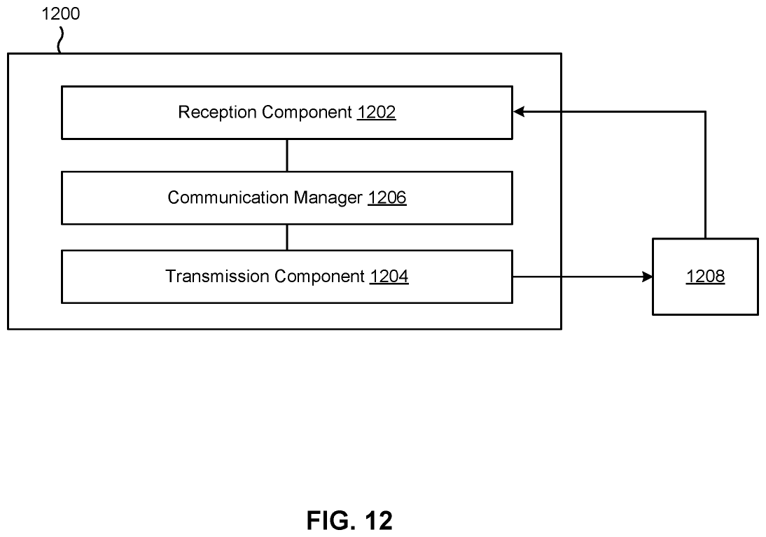

As shown in FIG. 9, in some aspects, process 900 may include receiving, from a first network node, configuration information indicating an LTM candidate cell associated with a second network node and a configuration, for the LTM candidate cell, of respective uplink resources associated with a plurality of TCI states (block 910). For example, the UE (e.g., using reception component 1202 and/or communication manager 1206, depicted in FIG. 12) may receive, from a first network node, configuration information indicating an LTM candidate cell associated with a second network node and a configuration, for the LTM candidate cell, of respective uplink resources associated with a plurality of TCI states, as described above.

As further shown in FIG. 9, in some aspects, process 900 may include transmitting, to the first network node, an L1 measurement report indicating one or more L1 measurements associated with the LTM candidate cell (block 920). For example, the UE (e.g., using transmission component 1204 and/or communication manager 1206, depicted in FIG. 12) may transmit, to the first network node, an L1 measurement report indicating one or more L1 measurements associated with the LTM candidate cell, as described above.

As further shown in FIG. 9, in some aspects, process 900 may include receiving, from the first network node, an LTM MAC-CE triggering LTM to the LTM candidate cell, the LTM MAC-CE indicating a TCI state, of the plurality of TCI states, to be used for the LTM candidate cell (block 930). For example, the UE (e.g., using reception component 1202 and/or communication manager 1206, depicted in FIG. 12) may receive, from the first network node, an LTM MAC-CE triggering LTM to the LTM candidate cell, the LTM MAC-CE indicating a TCI state, of the plurality of TCI states, to be used for the LTM candidate cell, as described above.

As further shown in FIG. 9, in some aspects, process 900 may include transmitting, to the second network node via the LTM candidate cell, an uplink communication on an uplink resource associated with the TCI state (block 940). For example, the UE (e.g., using transmission component 1204 and/or communication manager 1206, depicted in FIG. 12) may transmit, to the second network node via the LTM candidate cell, an uplink communication on an uplink resource associated with the TCI state, as described above.

Process 900 may include additional aspects, such as any single aspect or any combination of aspects described below and/or in connection with one or more other processes described elsewhere herein.

In a first aspect, the configuration information indicates a plurality of LTM candidate cells, including the LTM candidate cell, and a respective configuration, for each of the plurality of LTM candidate cells, of the respective uplink resources associated with the plurality of TCI states.

In a second aspect, alone or in combination with the first aspect, the configuration of the respective uplink resources associated with the plurality of TCI states is associated with an LTM candidate CG including the LTM candidate cell.

In a third aspect, alone or in combination with one or more of the first and second aspects, the configuration information indicates a plurality of LTM candidate CGs, including the LTM candidate CG, and a respective configuration, for each of the plurality of LTM candidate CGs, of the respective uplink resources associated with the plurality of TCI states.

In a fourth aspect, alone or in combination with one or more of the first through third aspects, the respective uplink resources associated with the plurality of TCI states include respective configured grant resources associated with the plurality of TCI states, and transmitting the uplink communication on the uplink resource associated with the TCI state includes transmitting a configured grant uplink communication on the configured grant resource associated with the TCI state.

In a fifth aspect, alone or in combination with one or more of the first through fourth aspects, the configured grant uplink communication includes uplink data scrambled by a C-RNTI associated with the UE.

In a sixth aspect, alone or in combination with one or more of the first through fifth aspects, the configured grant uplink communication includes a MAC-CE that includes an indication of a C-RNTI associated with the UE.

In a seventh aspect, alone or in combination with one or more of the first through sixth aspects, the respective uplink resources associated with the plurality of TCI states include respective SR or SRS resources associated with the plurality of TCI states, and transmitting the uplink communication on the uplink resource associated with the TCI state includes transmitting an SR or SRS on the SR or SRS resource associated with the TCI state.

In an eighth aspect, alone or in combination with one or more of the first through seventh aspects, transmitting the SR or SRS on the SR or SRS resource associated with the TCI state includes transmitting the SR or SRS using a frequency part, of the SR or SRS resource, associated with the UE, wherein the frequency part associated with the UE is indicated in the configuration information.

In a ninth aspect, alone or in combination with one or more of the first through eighth aspects, process 900 includes receiving, based at least in part on transmitting the SR or SRS, a downlink communication including an uplink grant, the downlink communication associated with a C-RNTI associated with the UE, and transmitting an RRC configuration complete message based at least in part on receiving the downlink communication including the uplink grant.

In a tenth aspect, alone or in combination with one or more of the first through ninth aspects, the first network node is a first DU and the second network node is a second DU.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a first network node, in accordance with the present disclosure. Example process 1000 is an example where the first network node (e.g., network node 110) performs operations associated with CG TCI management for LTM.

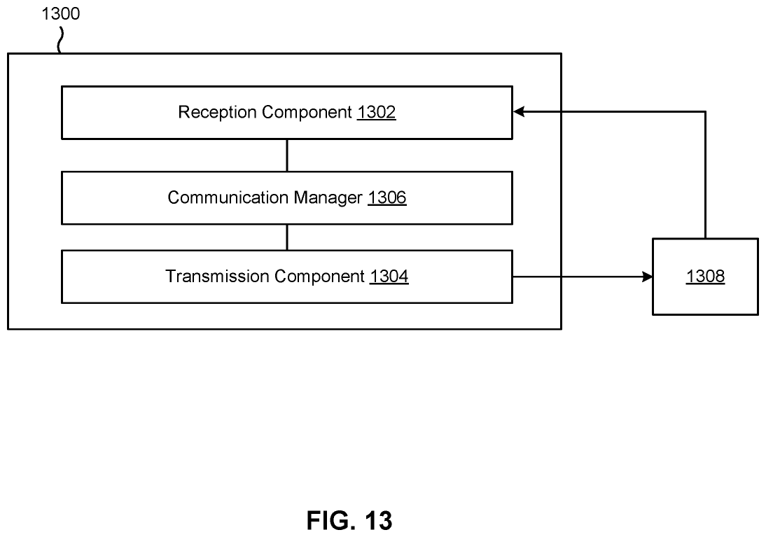

As shown in FIG. 10, in some aspects, process 1000 may include receiving, from a second network node, an indication of a TCI group associated with a cell or CG, associated with the first network node, that is an LTM candidate cell or CG for one or more UEs, wherein the TCI group includes one or more candidate TCI states for the cell or CG (block 1010). For example, the first network node (e.g., using reception component 1302 and/or communication manager 1306, depicted in FIG. 13) may receive, from a second network node, an indication of a TCI group associated with a cell or CG, associated with the first network node, that is an LTM candidate cell or CG for one or more UEs, wherein the TCI group includes one or more candidate TCI states for the cell or CG, as described above.

As further shown in FIG. 10, in some aspects, process 1000 may include monitoring uplink resources associated with the one or more candidate TCI states of the TCI group (block 1020). For example, the first network node (e.g., using communication manager 1306, depicted in FIG. 13) may monitor uplink resources associated with the one or more candidate TCI states of the TCI group, as described above.

As further shown in FIG. 10, in some aspects, process 1000 may include receiving, from a UE of the one or more UEs and on an uplink resource associated with a candidate TCI state of the one or more candidate TCI states of the TCI group, an uplink communication associated with LTM to the cell or CG (block 1030). For example, the first network node (e.g., using reception component 1302 and/or communication manager 1306, depicted in FIG. 13) may receive, from a UE of the one or more UEs and on an uplink resource associated with a candidate TCI state of the one or more candidate TCI states of the TCI group, an uplink communication associated with LTM to the cell or CG, as described above.

Process 1000 may include additional aspects, such as any single aspect or any combination of aspects described below and/or in connection with one or more other processes described elsewhere herein.

In a first aspect, receiving the indication of the TCI group includes receiving the indication of the TCI group prior to a determination to trigger LTM for the UE of the one or more UEs.

In a second aspect, alone or in combination with the first aspect, receiving the indication of the TCI group includes periodically receiving the indication of the TCI group.

In a third aspect, alone or in combination with one or more of the first and second aspects, receiving the indication of the TCI group includes receiving the indication of the TCI group in connection with an update to the one or more candidate TCI states of the TCI group.

In a fourth aspect, alone or in combination with one or more of the first through third aspects, receiving the indication of the TCI group includes receiving the indication of the TCI group responsive to a detection of a TCI group notification triggering condition associated with a potential LTM for at least one UE of the one or more UEs.

In a fifth aspect, alone or in combination with one or more of the first through fourth aspects, the detection of the TCI group notification triggering condition is prior to a determination, by the second network node, to trigger LTM for the at least one UE of the one or more UEs.

In a sixth aspect, alone or in combination with one or more of the first through fifth aspects, monitoring the uplink resources associated with the one or more candidate TCI states of the TCI group includes monitoring the uplink resources associated with the one or more candidate TCI states of the TCI group for a time duration, responsive to receiving the indication of the TCI group.

In a seventh aspect, alone or in combination with one or more of the first through sixth aspects, the indication of the TCI group indicates respective TCI groups for a plurality of cells or CGs associated with the first network node, the plurality of cells or CGs including the cell or CG.

In an eighth aspect, alone or in combination with one or more of the first through seventh aspects, the uplink resources associated with the one or more candidate TCI states of the TCI group include configured grant resources associated with the one or more candidate TCI states of the TCI group, and receiving the uplink communication includes receiving a configured grant uplink communication on a configured grant resource associated with the candidate TCI state of the one or more candidate TCI states of the TCI group.

In a ninth aspect, alone or in combination with one or more of the first through eighth aspects, the configured grant uplink communication includes uplink data scrambled by a C-RNTI associated with the UE of the one or more UEs.

In a tenth aspect, alone or in combination with one or more of the first through ninth aspects, the configured grant uplink communication includes a MAC-CE that includes an indication of a C-RNTI associated with the UE of the one or more UEs.

In an eleventh aspect, alone or in combination with one or more of the first through tenth aspects, the uplink resources associated with the one or more candidate TCI states of the TCI group include SR or SRS resources associated with the one or more candidate TCI states of the TCI group, and receiving the uplink communication includes receiving an SR or SRS on an SR or SRS resource associated with the candidate TCI state of the one or more candidate TCI states of the TCI group.

In a twelfth aspect, alone or in combination with one or more of the first through eleventh aspects, receiving the SR or SRS on the SR or SRS resource associated with the candidate TCI state includes receiving the SR or SRS in a frequency part, of the respective SR or SRS resource, associated with the UE of the one or more UEs.

In a thirteenth aspect, alone or in combination with one or more of the first through twelfth aspects, process 1000 includes transmitting, based at least in part on receiving the SR or SRS, one or more downlink communications, each including an uplink grant, and each associated with a C-RNTI associated with a respective UE of the one or more UEs, and receiving, from the UE of the one or more UEs, an RRC configuration complete message based at least in part on the uplink grant included in the downlink communication, of the one or more downlink communications, associated with the C-RNTI associated with the UE.

In a fourteenth aspect, alone or in combination with one or more of the first through thirteenth aspects, the first network node is a first DU and the second network node is a second DU.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a first network node, in accordance with the present disclosure. Example process 1100 is an example where the first network node (e.g., first network node 110) performs operations associated with CG TCI management for LTM.

As shown in FIG. 11, in some aspects, process 1100 may include transmitting, to one or more UEs, configuration information indicating an LTM candidate cell or CG associated with a second network node and a configuration, for the LTM candidate cell or CG, of respective uplink resources associated with a plurality of TCI states (block 1110). For example, the first network node (e.g., using transmission component 1304 and/or communication manager 1306, depicted in FIG. 13) may transmit, to one or more UEs, configuration information indicating an LTM candidate cell or CG associated with a second network node and a configuration, for the LTM candidate cell or CG, of respective uplink resources associated with a plurality of TCI states, as described above.

As further shown in FIG. 11, in some aspects, process 1100 may include receiving, from the one or more UEs, L1 measurement reports indicating one or more L1 measurements associated with the LTM candidate cell (block 1120). For example, the first network node (e.g., using reception component 1302 and/or communication manager 1306, depicted in FIG. 13) may receive, from the one or more UEs, L1 measurement reports indicating one or more L1 measurements associated with the LTM candidate cell, as described above.

As further shown in FIG. 11, in some aspects, process 1100 may include transmitting, to the second network node, an indication of a TCI group associated with the LTM candidate cell or CG associated with the second network node, wherein the TCI group includes one or more candidate TCI states, of the plurality of TCI states, for the LTM candidate cell or CG (block 1130). For example, the first network node (e.g., using transmission component 1304 and/or communication manager 1306, depicted in FIG. 13) may transmit, to the second network node, an indication of a TCI group associated with the LTM candidate cell or CG associated with the second network node, wherein the TCI group includes one or more candidate TCI states, of the plurality of TCI states, for the LTM candidate cell or CG, as described above.

Process 1100 may include additional aspects, such as any single aspect or any combination of aspects described below and/or in connection with one or more other processes described elsewhere herein.

In a first aspect, process 1100 includes transmitting, to a UE of the one or more UEs, an LTM MAC-CE triggering LTM to the LTM candidate cell or CG, the LTM MAC-CE indicating a TCI state, of the one or more candidate TCI states, for the LTM candidate cell or CG.

In a second aspect, alone or in combination with the first aspect, transmitting the indication of the TCI group includes transmitting the indication of the TCI group prior to a determination to trigger the LTM for the UE of the one or more UEs.

In a third aspect, alone or in combination with one or more of the first and second aspects, transmitting the indication of the TCI group includes periodically transmitting the indication of the TCI group.

In a fourth aspect, alone or in combination with one or more of the first through third aspects, transmitting the indication of the TCI group includes transmitting the indication of the TCI group responsive to a determination, based at least in part on the L1 measurement reports, to update the one or more candidate TCI states of the TCI group.

In a fifth aspect, alone or in combination with one or more of the first through fourth aspects, transmitting the indication of the TCI group includes transmitting the indication of the TCI group responsive to detection of a TCI group notification triggering condition associated with a potential LTM for at least one UE of the one or more UEs.

In a sixth aspect, alone or in combination with one or more of the first through fifth aspects, the detection of the TCI group notification triggering condition is prior to a determination to trigger LTM for the at least one UE of the one or more UEs.

In a seventh aspect, alone or in combination with one or more of the first through sixth aspects, the indication of the TCI group indicates respective TCI groups for a plurality of LTM candidate cells or CGs associated with the second network node, the plurality of LTM candidate cells or CGs including the LTM candidate cell or CG.

In an eighth aspect, alone or in combination with one or more of the first through seventh aspects, the configuration information indicates a plurality of LTM candidate cells or CGs, including the LTM candidate cell or CG, and a respective configuration, for each of the plurality of LTM candidate cells or CGs, of the respective uplink resources associated with the plurality of TCI states.

In a ninth aspect, alone or in combination with one or more of the first through eighth aspects, the respective uplink resources associated with the plurality of TCI states include respective configured grant resources associated with the plurality of TCI states.

In a tenth aspect, alone or in combination with one or more of the first through ninth aspects, the respective uplink resources associated with the plurality of TCI states include respective SR or SRS resources associated with the plurality of TCI states.

In an eleventh aspect, alone or in combination with one or more of the first through tenth aspects, the configuration information indicates a respective frequency part, of the respective SR or SRS resources associated with the plurality of TCI states, associated with each UE of the one or more UEs.

In a twelfth aspect, alone or in combination with one or more of the first through eleventh aspects, transmitting the configuration information includes transmitting, to one or more first UEs, first configuration information indicating an association between a set of uplink resources and a first set of TCI states, and transmitting to one or more second UEs, second configuration information indicating an association between the set of uplink resources and a second set of TCI states.

In a thirteenth aspect, alone or in combination with one or more of the first through twelfth aspects, the first network node is a first DU and the second network node is a second DU.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram of an example apparatus 1200 for wireless communication, in accordance with the present disclosure. The apparatus 1200 may be a UE, or a UE may include the apparatus 1200. In some aspects, the apparatus 1200 includes a reception component 1202, a transmission component 1204, and/or a communication manager 1206, which may be in communication with one another (for example, via one or more buses and/or one or more other components). In some aspects, the communication manager 1206 is the communication manager 140 described in connection with FIG. 1. As shown, the apparatus 1200 may communicate with another apparatus 1208, such as a UE or a network node (such as a CU, a DU, an RU, or a base station), using the reception component 1202 and the transmission component 1204.

In some aspects, the apparatus 1200 may be configured to perform one or more operations described herein in connection with FIGS. 6-8. Additionally, or alternatively, the apparatus 1200 may be configured to perform one or more processes described herein, such as process 900 of FIG. 9, or a combination thereof. In some aspects, the apparatus 1200 and/or one or more components shown in FIG. 12 may include one or more components of the UE described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1208. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the UE described in connection with FIG. 2.

The transmission component 1204 may transmit communications, such as reference signals, control information, data communications, or a combination thereof, to the apparatus 1208. In some aspects, one or more other components of the apparatus 1200 may generate communications and may provide the generated communications to the transmission component 1204 for transmission to the apparatus 1208. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1208. In some aspects, the transmission component 1204 may include one or more antennas, a modem, a modulator, a transmit MIMO processor, a transmit processor, a controller/processor, a memory, or a combination thereof, of the UE described in connection with FIG. 2. In some aspects, the transmission component 1204 may be co-located with the reception component 1202 in a transceiver.

The communication manager 1206 may support operations of the reception component 1202 and/or the transmission component 1204. For example, the communication manager 1206 may receive information associated with configuring reception of communications by the reception component 1202 and/or transmission of communications by the transmission component 1204. Additionally, or alternatively, the communication manager 1206 may generate and/or provide control information to the reception component 1202 and/or the transmission component 1204 to control reception and/or transmission of communications.

The reception component 1202 may receive, from a first network node, configuration information indicating an LTM candidate cell associated with a second network node and a configuration, for the LTM candidate cell, of respective uplink resources associated with a plurality of TCI states. The transmission component 1204 may transmit, to the first network node, an L1 measurement report indicating one or more L1 measurements associated with the LTM candidate cell. The reception component 1202 may receive, from the first network node, an LTM MAC-CE triggering LTM to the LTM candidate cell, the LTM MAC-CE indicating a TCI state, of the plurality of TCI states, to be used for the LTM candidate cell. The transmission component 1204 may transmit, to the second network node via the LTM candidate cell, an uplink communication on an uplink resource associated with the TCI state.

The reception component 1202 may receive, based at least in part on transmitting the SR or SRS, a downlink communication including an uplink grant, the downlink communication associated with a C-RNTI associated with the UE.

The transmission component 1204 may transmit an RRC configuration complete message based at least in part on receiving the downlink communication including the uplink grant.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

FIG. 13 is a diagram of an example apparatus 1300 for wireless communication, in accordance with the present disclosure. The apparatus 1300 may be a network node, or a network node may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 6-8. Additionally, or alternatively, the apparatus 1300 may be configured to perform one or more processes described herein, such as process 1000 of FIG. 10, process 1100 of FIG. 11, or a combination thereof. In some aspects, the apparatus 1300 and/or one or more components shown in FIG. 13 may include one or more components of the network node described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, a modem, a demodulator, a MIMO detector, a receive processor, a controller/processor, a memory, or a combination thereof, of the network node described in connection with FIG. 2. In some aspects, the reception component 1302 and/or the transmission component 1304 may include or may be included in a network interface. The network interface may be configured to obtain and/or output signals for the apparatus 1300 via one or more communications links, such as a backhaul link, a midhaul link, and/or a fronthaul link.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, a modem, a modulator, a transmit MIMO processor, a transmit processor, a controller/processor, a memory, or a combination thereof, of the network node described in connection with FIG. 2. In some aspects, the transmission component 1304 may be co-located with the reception component 1302 in a transceiver.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

In some aspects, the reception component 1302 may receive, from another network node, an indication of a TCI group associated with a cell or CG, associated with the network node, that is an LTM candidate cell or CG for one or more UEs, wherein the TCI group includes one or more candidate TCI states for the cell or CG. The communication manager 1306 may monitor uplink resources associated with the one or more candidate TCI states of the TCI group. The reception component 1302 may receive, from a UE of the one or more UEs and on an uplink resource associated with a candidate TCI state of the one or more candidate TCI states of the TCI group, an uplink communication associated with LTM to the cell or CG.

The transmission component 1304 may transmit, based at least in part on receiving the SR or SRS, one or more downlink communications, each including an uplink grant, and each associated with a C-RNTI associated with a respective UE of the one or more UEs.

The reception component 1302 may receive, from the UE of the one or more UEs, an RRC configuration complete message based at least in part on the uplink grant included in the downlink communication, of the one or more downlink communications, associated with the C-RNTI associated with the UE.

In some aspects, the transmission component 1304 may transmit, to one or more UEs, configuration information indicating an LTM candidate cell or CG associated with another network node and a configuration, for the LTM candidate cell or CG, of respective uplink resources associated with a plurality of TCI states. The reception component 1302 may receive, from the one or more UEs, L1 measurement reports indicating one or more L1 measurements associated with the LTM candidate cell. The transmission component 1304 may transmit, to the other network node, an indication of a TCI group associated with the LTM candidate cell or CG associated with the other network node, wherein the TCI group includes one or more candidate TCI states, of the plurality of TCI states, for the LTM candidate cell or CG.

The transmission component 1304 may transmit, to a UE of the one or more UEs, an LTM MAC-CE triggering LTM to the LTM candidate cell or CG, the LTM MAC-CE indicating a TCI state, of the one or more candidate TCI states, for the LTM candidate cell or CG.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

The following provides an overview of some Aspects of the present disclosure:

Aspect 1: A method of wireless communication performed by a user equipment (UE), comprising: receiving, from a first network node, configuration information indicating a layer 1/layer 2 triggered mobility (LTM) candidate cell associated with a second network node and a configuration, for the LTM candidate cell, of respective uplink resources associated with a plurality of transmission configuration indicator (TCI) states; transmitting, to the first network node, a layer 1 (L1) measurement report indicating one or more L1 measurements associated with the LTM candidate cell; receiving, from the first network node, an LTM medium access control (MAC) control element (MAC-CE) triggering LTM to the LTM candidate cell, the LTM MAC-CE indicating a TCI state, of the plurality of TCI states, to be used for the LTM candidate cell; and transmitting, to the second network node via the LTM candidate cell, an uplink communication on an uplink resource associated with the TCI state.

Aspect 2: The method of Aspect 1, wherein the configuration information indicates a plurality of LTM candidate cells, including the LTM candidate cell, and a respective configuration, for each of the plurality of LTM candidate cells, of the respective uplink resources associated with the plurality of TCI states.

Aspect 3: The method of Aspects 1, wherein the configuration of the respective uplink resources associated with the plurality of TCI states is associated with an LTM candidate cell group (CG) including the LTM candidate cell.

Aspect 4: The method of Aspect 3, wherein the configuration information indicates a plurality of LTM candidate CGs, including the LTM candidate CG, and a respective configuration, for each of the plurality of LTM candidate CGs, of the respective uplink resources associated with the plurality of TCI states.

Aspect 5: The method of any of Aspects 1-4, wherein the respective uplink resources associated with the plurality of TCI states include respective configured grant resources associated with the plurality of TCI states, and wherein transmitting the uplink communication on the uplink resource associated with the TCI state comprises: transmitting a configured grant uplink communication on the configured grant resource associated with the TCI state.

Aspect 6: The method of Aspect 5, wherein the configured grant uplink communication includes uplink data scrambled by a cell radio network temporary identifier (C-RNTI) associated with the UE.

Aspect 7: The method of any of Aspects 5-6, wherein the configured grant uplink communication includes a MAC-CE that includes an indication of a cell radio network temporary identifier (C-RNTI) associated with the UE.

Aspect 8: The method of any of Aspects 1-4, wherein the respective uplink resources associated with the plurality of TCI states include respective scheduling request (SR) or sounding reference signal (SRS) resources associated with the plurality of TCI states, and wherein transmitting the uplink communication on the uplink resource associated with the TCI state comprises: transmitting an SR or SRS on the SR or SRS resource associated with the TCI state.

Aspect 9: The method of Aspect 8, wherein transmitting the SR or SRS on the SR or SRS resource associated with the TCI state comprises: transmitting the SR or SRS using a frequency part, of the SR or SRS resource, associated with the UE, wherein the frequency part associated with the UE is indicated in the configuration information.

Aspect 10: The method of any of Aspects 8-9, further comprising: receiving, based at least in part on transmitting the SR or SRS, a downlink communication including an uplink grant, the downlink communication associated with a cell radio network temporary identifier (C-RNTI) associated with the UE; and transmitting a radio resource control (RRC) configuration complete message based at least in part on receiving the downlink communication including the uplink grant.

Aspect 11: The method of any of Aspects 1-10, wherein the first network node is a first distributed unit (DU) and the second network node is a second DU.

Aspect 12: A method of wireless communication performed by a first network node, comprising: receiving, from a second network node, an indication of a transmission configuration indicator (TCI) group associated with a cell or cell group (CG), associated with the first network node, that is a layer 1/layer 2 triggered mobility (LTM) candidate cell or CG for one or more user equipments (UEs), wherein the TCI group includes one or more candidate TCI states for the cell or CG; monitoring uplink resources associated with the one or more candidate TCI states of the TCI group; and receiving, from a UE of the one or more UEs and on an uplink resource associated with a candidate TCI state of the one or more candidate TCI states of the TCI group, an uplink communication associated with LTM to the cell or CG.

Aspect 13: The method of Aspect 12, wherein receiving the indication of the TCI group comprises: receiving the indication of the TCI group prior to a determination, by the second network node, to trigger LTM for the UE of the one or more UEs.

Aspect 14: The method of any of Aspects 12-13, wherein receiving the indication of the TCI group comprises: periodically receiving the indication of the TCI group.

Aspect 15: The method of any of Aspects 12-14, wherein receiving the indication of the TCI group comprises: receiving the indication of the TCI group in connection with an update to the one or more candidate TCI states of the TCI group.

Aspect 16: The method of any of Aspects 12-13, wherein receiving the indication of the TCI group comprises: receiving the indication of the TCI group responsive to a detection, by the second network node, of a TCI group notification triggering condition associated with a potential LTM for at least one UE of the one or more UEs.

Aspect 17: The method of Aspect 16, wherein the detection of the TCI group notification triggering condition is prior to a determination, by the second network node, to trigger LTM for the at least one UE of the one or more UEs.

Aspect 18: The method of any of Aspects 16-17, wherein monitoring the uplink resources associated with the one or more candidate TCI states of the TCI group comprises: monitoring the uplink resources associated with the one or more candidate TCI states of the TCI group for a time duration, responsive to receiving the indication of the TCI group.

Aspect 19: The method of any of Aspects 12-18, wherein the indication of the TCI group indicates respective TCI groups for a plurality of cells or CGs associated with the first network node, the plurality of cells or CGs including the cell or CG.

Aspect 20: The method of any of Aspects 12-19, wherein the uplink resources associated with the one or more candidate TCI states of the TCI group include configured grant resources associated with the one or more candidate TCI states of the TCI group, and wherein receiving the uplink communication comprises: receiving a configured grant uplink communication on a configured grant resource associated with the candidate TCI state of the one or more candidate TCI states of the TCI group.

Aspect 21: The method of Aspect 20, wherein the configured grant uplink communication includes uplink data scrambled by a cell radio network temporary identifier (C-RNTI) associated with the UE of the one or more UEs.

Aspect 22: The method of any of Aspects 20-21, wherein the configured grant uplink communication includes a medium access control (MAC) control element (MAC-CE) that includes an indication of a cell radio network temporary identifier (C-RNTI) associated with the UE of the one or more UEs.

Aspect 23: The method of any of Aspects 12-19, wherein the uplink resources associated with the one or more candidate TCI states of the TCI group include scheduling request (SR) or sounding reference signal (SRS) resources associated with the one or more candidate TCI states of the TCI group, and wherein receiving the uplink communication comprises: receiving an SR or SRS on an SR or SRS resource associated with the candidate TCI state of the one or more candidate TCI states of the TCI group.

Aspect 24: The method of Aspect 23, wherein receiving the SR or SRS on the SR or SRS resource associated with the candidate TCI state comprises: receiving the SR or SRS in a frequency part, of the respective SR or SRS resource, associated with the UE of the one or more UEs.

Aspect 25: The method of any of Aspects 23-24, further comprising: transmitting, based at least in part on receiving the SR or SRS, one or more downlink communications, each including an uplink grant, and each associated with a cell radio network temporary identifier (C-RNTI) associated with a respective UE of the one or more UEs; and receiving, from the UE of the one or more UEs, a radio resource control (RRC) configuration complete message based at least in part on the uplink grant included in the downlink communication, of the one or more downlink communications, associated with the C-RNTI associated with the UE.

Aspect 26: The method of any of Aspects 12-25, wherein the first network node is a first distributed unit (DU) and the second network node is a second DU.

Aspect 27: A method of wireless communication performed by a first network node, comprising: transmitting, to one or more user equipments (UEs), configuration information indicating a layer 1/layer 2 triggered mobility (LTM) candidate cell or cell group (CG) associated with a second network node and a configuration, for the LTM candidate cell or CG, of respective uplink resources associated with a plurality of transmission configuration indicator (TCI) states; receiving, from the one or more UEs, layer 1 (L1) measurement reports indicating one or more L1 measurements associated with the LTM candidate cell; and transmitting, to the second network node, an indication of a TCI group associated with the LTM candidate cell or CG associated with the second network node, wherein the TCI group includes one or more candidate TCI states, of the plurality of TCI states, for the LTM candidate cell or CG.

Aspect 28: The method of Aspect 27, further comprising: transmitting, to a UE of the one or more UEs, an LTM medium access control (MAC) control element (MAC-CE) triggering LTM to the LTM candidate cell or CG, the LTM MAC-CE indicating a TCI state, of the one or more candidate TCI states, for the LTM candidate cell or CG.

Aspect 29: The method of Aspect 28, wherein transmitting the indication of the TCI group comprises: transmitting the indication of the TCI group prior to a determination to trigger the LTM for the UE of the one or more UEs.

Aspect 30: The method of any of Aspects 27-29, wherein transmitting the indication of the TCI group comprises: periodically transmitting the indication of the TCI group.

Aspect 31: The method of any of Aspects 27-30, wherein transmitting the indication of the TCI group comprises: transmitting the indication of the TCI group responsive to a determination, based at least in part on the L1 measurement reports, to update the one or more candidate TCI states of the TCI group.

Aspect 32: The method of any of Aspects 27-29, wherein transmitting the indication of the TCI group comprises: transmitting the indication of the TCI group responsive to detection of a TCI group notification triggering condition associated with a potential LTM for at least one UE of the one or more UEs.

Aspect 33: The method of Aspect 32, wherein the detection of the TCI group notification triggering condition is prior to a determination to trigger LTM for the at least one UE of the one or more UEs.

Aspect 34: The method of any of Aspects 27-33, wherein the indication of the TCI group indicates respective TCI groups for a plurality of LTM candidate cells or CGs associated with the second network node, the plurality of LTM candidate cells or CGs including the LTM candidate cell or CG.

Aspect 35: The method of any of Aspects 27-34, wherein the configuration information indicates a plurality of LTM candidate cells or CGs, including the LTM candidate cell or CG, and a respective configuration, for each of the plurality of LTM candidate cells or CGs, of the respective uplink resources associated with the plurality of TCI states.

Aspect 36: The method of any of Aspects 27-35, wherein the respective uplink resources associated with the plurality of TCI states include respective configured grant resources associated with the plurality of TCI states.

Aspect 37: The method of any of Aspects 27-35, wherein the respective uplink resources associated with the plurality of TCI states include respective scheduling request (SR) or sounding reference signal (SRS) resources associated with the plurality of TCI states.

Aspect 38: The method of Aspect 37, wherein the configuration information indicates a respective frequency part, of the respective SR or SRS resources associated with the plurality of TCI states, associated with each UE of the one or more UEs.

Aspect 39: The method of any of Aspects 27-38, wherein transmitting the configuration information comprises: transmitting, to one or more first UEs, first configuration information indicating an association between a set of uplink resources and a first set of TCI states; and transmitting to one or more second UEs, second configuration information indicating an association between the set of uplink resources and a second set of TCI states.

Aspect 40: The method of any of Aspects 27-39, wherein the first network node is a first distributed unit (DU) and the second network node is a second DU.

Aspect 41: An apparatus for wireless communication at a device, comprising a processor; memory coupled with the processor; and instructions stored in the memory and executable by the processor to cause the apparatus to perform the method of one or more of Aspects 1-40.

Aspect 42: A device for wireless communication, comprising a memory and one or more processors coupled to the memory, the one or more processors configured to perform the method of one or more of Aspects 1-40.

Aspect 43: An apparatus for wireless communication, comprising at least one means for performing the method of one or more of Aspects 1-40.

Aspect 44: A non-transitory computer-readable medium storing code for wireless communication, the code comprising instructions executable by a processor to perform the method of one or more of Aspects 1-40.

Aspect 45: A non-transitory computer-readable medium storing a set of instructions for wireless communication, the set of instructions comprising one or more instructions that, when executed by one or more processors of a device, cause the device to perform the method of one or more of Aspects 1-40.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
one or more processors, in communication with one or more memories, the one or more processors configured individually or in any combination to:
receive, from a first network node, configuration information indicating a layer 1/layer 2 triggered mobility (LTM) candidate cell associated with a second network node and a configuration, for the LTM candidate cell, of respective uplink resources associated with a plurality of transmission configuration indicator (TCI) states;
transmit, to the first network node, a layer 1 (L1) measurement report indicating one or more L1 measurements associated with the LTM candidate cell;
receive, from the first network node, an LTM medium access control (MAC) control element (MAC-CE) triggering LTM to the LTM candidate cell, the LTM MAC-CE indicating a TCI state, of the plurality of TCI states, to be used for the LTM candidate cell; and
transmit, to the second network node via the LTM candidate cell, an uplink communication on an uplink resource associated with the TCI state.

2. The UE of claim 1, wherein the configuration of the respective uplink resources associated with the plurality of TCI states is associated with an LTM candidate cell group (CG) including the LTM candidate cell.

3. The UE of claim 1, wherein the respective uplink resources associated with the plurality of TCI states include respective configured grant resources associated with the plurality of TCI states, and wherein, to transmit the uplink communication on the uplink resource associated with the TCI state, the one or more processors are configured individually or in any combination to:
transmit a configured grant uplink communication on the configured grant resource associated with the TCI state.

4. The UE of claim 3, wherein the configured grant uplink communication includes uplink data scrambled by a cell radio network temporary identifier (C-RNTI) associated with the UE.

5. The UE of claim 3, wherein the configured grant uplink communication includes a MAC-CE that includes an indication of a cell radio network temporary identifier (C-RNTI) associated with the UE.

6. The UE of claim 1, wherein the respective uplink resources associated with the plurality of TCI states include respective scheduling request (SR) or sounding reference signal (SRS) resources associated with the plurality of TCI states, and wherein, to transmit the uplink communication on the uplink resource associated with the TCI state, the one or more processors are configured individually or in any combination to:
transmit an SR or SRS on the SR or SRS resource associated with the TCI state.

7. The UE of claim 6, wherein, to transmit the SR or SRS on the SR or SRS resource associated with the TCI state, the one or more processors are configured individually or in any combination to:
transmit the SR or SRS using a frequency part, of the SR or SRS resource, associated with the UE, wherein the frequency part associated with the UE is indicated in the configuration information.

8. The UE of claim 6, wherein the one or more processors are further configured individually or in any combination to
receive, based at least in part on transmitting the SR or SRS, a downlink communication including an uplink grant, the downlink communication associated with a cell radio network temporary identifier (C-RNTI) associated with the UE; and
transmit a radio resource control (RRC) configuration complete message based at least in part on receiving the downlink communication including the uplink grant.

9. A first network node for wireless communication, comprising:
one or more processors, in communication with one or more memories, the one or more processors configured individually or in any combination to:
receive, from a second network node, an indication of a transmission configuration indicator (TCI) group associated with a cell or cell group (CG), associated with the first network node, that is a layer 1/layer 2 triggered mobility (LTM) candidate cell or CG for one or more user equipments (UEs), wherein the TCI group includes one or more candidate TCI states for the cell or CG;
monitor uplink resources associated with the one or more candidate TCI states of the TCI group; and
receive, from a UE of the one or more UEs and on an uplink resource associated with a candidate TCI state of the one or more candidate TCI states of the TCI group, an uplink communication associated with LTM to the cell or CG.

10. The first network node of claim 9, wherein, to receive the indication of the TCI group, the one or more processors are configured individually or in any combination to at least one of:
periodically receive the indication of the TCI group; or
receive the indication of the TCI group in connection with an update to the one or more candidate TCI states of the TCI group.

11. The first network node of claim 9, wherein, to receive the indication of the TCI group, the one or more processors are configured individually or in any combination to:
receive the indication of the TCI group responsive to a detection of a TCI group notification triggering condition associated with a potential LTM for at least one UE of the one or more UEs.

12. The first network node of claim 11, wherein, to monitor the uplink resources associated with the one or more candidate TCI states of the TCI group, the one or more processors are configured individually or in any combination to:
monitor the uplink resources associated with the one or more candidate TCI states of the TCI group for a time duration, responsive to receiving the indication of the TCI group.

13. The first network node of claim 9, wherein the uplink resources associated with the one or more candidate TCI states of the TCI group include configured grant resources associated with the one or more candidate TCI states of the TCI group, and wherein, to receive the uplink communication, the one or more processors are configured individually or in any combination to:
receive a configured grant uplink communication on a configured grant resource associated with the candidate TCI state of the one or more candidate TCI states of the TCI group.

14. The first network node of claim 13, wherein the configured grant uplink communication includes uplink data scrambled by a cell radio network temporary identifier (C-RNTI) associated with the UE of the one or more UEs.

15. The first network node of claim 13, wherein the configured grant uplink communication includes a medium access control (MAC) control element (MAC-CE) that includes an indication of a cell radio network temporary identifier (C-RNTI) associated with the UE of the one or more UEs.

16. The first network node of claim 9, wherein the uplink resources associated with the one or more candidate TCI states of the TCI group include scheduling request (SR) or sounding reference signal (SRS) resources associated with the one or more candidate TCI states of the TCI group, and wherein, to receive the uplink communication, the one or more processors are configured individually or in any combination to:
receive an SR or SRS on an SR or SRS resource associated with the candidate TCI state of the one or more candidate TCI states of the TCI group.

17. The first network node of claim 16, wherein, to receive the SR or SRS on the SR or SRS resource associated with the candidate TCI state, the one or more processors are configured individually or in any combination to:
receive the SR or SRS in a frequency part, of the respective SR or SRS resource, associated with the UE of the one or more UEs.

18. The first network node of claim 16, wherein the one or more processors are further configured individually or in any combination to:
transmit, based at least in part on receiving the SR or SRS, one or more downlink communications, each including an uplink grant, and each associated with a cell radio network temporary identifier (C-RNTI) associated with a respective UE of the one or more UEs; and
receive, from the UE of the one or more UEs, a radio resource control (RRC) configuration complete message based at least in part on the uplink grant included in the downlink communication, of the one or more downlink communications, associated with the C-RNTI associated with the UE.

19. A first network node for wireless communication, comprising:
one or more processors, in communication with one or more memories, the one or more processors configured individually or in any combination to:
transmit, to one or more user equipments (UEs), configuration information indicating a layer 1/layer 2 triggered mobility (LTM) candidate cell or cell group (CG) associated with a second network node and a configuration, for the LTM candidate cell or CG, of respective uplink resources associated with a plurality of transmission configuration indicator (TCI) states;
receive, from the one or more UEs, layer 1 (L1) measurement reports indicating one or more L1 measurements associated with the LTM candidate cell; and
transmit, to the second network node, an indication of a TCI group associated with the LTM candidate cell or CG associated with the second network node, wherein the TCI group includes one or more candidate TCI states, of the plurality of TCI states, for the LTM candidate cell or CG.

20. The first network node of claim 19, wherein the one or more processors are further configured individually or in any combination to:
transmit, to a UE of the one or more UEs, an LTM medium access control (MAC) control element (MAC-CE) triggering LTM to the LTM candidate cell or CG, the LTM MAC-CE indicating a TCI state, of the one or more candidate TCI states, for the LTM candidate cell or CG.

21. The first network node of claim 20, wherein, to transmit the indication of the TCI group, the one or more processors are configured individually or in any combination to:
transmit the indication of the TCI group prior to a determination to trigger the LTM for the UE of the one or more UEs.

22. The first network node of claim 19, wherein, to transmit the indication of the TCI group, the one or more processors are configured individually or in any combination to at least one of:
periodically transmit the indication of the TCI group; or
transmit the indication of the TCI group responsive to a determination, based at least in part on the L1 measurement reports, to update the one or more candidate TCJ states of the TCI group.

23. The first network node of claim 19, wherein, to transmit the indication of the TCI group, the one or more processors are configured individually or in any combination to:
transmit the indication of the TCI group responsive to detection of a TCI group notification triggering condition associated with a potential LTM for at least one UE of the one or more UEs.

24. The first network node of claim 23, wherein the detection of the TCI group notification triggering condition is prior to a determination to trigger LTM for the at least one UE of the one or more UEs.

25. The first network node of claim 19, wherein the indication of the TCI group indicates respective TCI groups for a plurality of LTM candidate cells or CGs associated with the second network node, the plurality of LTM candidate cells or CGs including the LTM candidate cell or CG.

26. The first network node of claim 19, wherein the configuration information indicates a plurality of LTM candidate cells or CGs, including the LTM candidate cell or CG, and a respective configuration, for each of the plurality of LTM candidate cells or CGs, of the respective uplink resources associated with the plurality of TC states.

27. The first network node of claim 19, wherein the respective uplink resources associated with the plurality of TCI states include respective configured grant resources associated with the plurality of TCI states.

28. The first network node of claim 19, wherein the respective uplink resources associated with the plurality of TCI states include respective scheduling request (SR) or sounding reference signal (SRS) resources associated with the plurality of TCI states.

29. The first network node of claim 28, wherein the configuration information indicates a respective frequency part, of the respective SR or SRS resources associated with the plurality of TCI states, associated with each UE of the one or more UEs.

30. A method of wireless communication performed by a user equipment (UE), comprising:
receiving, from a first network node, configuration information indicating a layer 1/layer 2 triggered mobility (LTM) candidate cell associated with a second network node and a configuration, for the LTM candidate cell, of respective uplink resources associated with a plurality of transmission configuration indicator (TCI) states;
transmitting, to the first network node, a layer 1 (L1) measurement report indicating one or more L1 measurements associated with the LTM candidate cell;
receiving, from the first network node, an LTM medium access control (MAC) control element (MAC-CE) triggering LTM to the LTM candidate cell, the LTM MAC-CE indicating a TCI state, of the plurality of TCI states, to be used for the LTM candidate cell; and
transmitting, to the second network node via the LTM candidate cell, an uplink communication on an uplink resource associated with the TCI state.
